(19) United States
(12) Patent Application Publication
(10) Pub. No.: US 2025/0098918 A1
(43) Pub. Date: Mar. 27, 2025

(54) CLEANER STATION

(71) Applicant: LG Electronics Inc., Seoul (KR)

(72) Inventors: Kyeongho CHO, Seoul (KR); Kietak HYUN, Seoul (KR); Jongil PARK, Seoul (KR); Hyunsup SONG, Seoul (KR)

(21) Appl. No.: 18/727,883

(22) PCT Filed: Jan. 10, 2023
(86) PCT No.: PCT/KR2023/000421

§ 371 Date: Jul. 10, 2024

Related U.S. Application Data
(60) Provisional application No. 63/297,872, filed on Jan. 10, 2022.

(30) Foreign Application Priority Data
May 23, 2022 (KR) 10-2022-0062890

(51) Int. Cl. A47L 9/14; A47L 9/00; F26B 3/02

(52) U.S. Cl. CPC A47L 9/149; A47L 9/0063; F26B 3/02

(57) ABSTRACT

The present disclosure relates to a cleaner station including a housing, a coupling part disposed in the housing and including a coupling surface to which at least a part of a cleaner is coupled, a suction flow path having one end connected to a dust passage hole formed in the coupling surface, a dust collecting part connected to the other end of the suction flow path and including a dust bag configured to capture dust in a dust bin of the cleaner, and a dust collecting chamber configured to accommodate the dust bag, and a drying part configured to dry an interior of the dust bag by generating an airflow to be introduced into the dust bag in the dust collecting chamber, thereby maintaining a clean, hygienic state of an interior of the dust collecting part.

### TECHNICAL FIELD

The present disclosure relates to a cleaner station, and more particularly, to a cleaner station capable of maintaining a clean, hygienic state by drying an interior of a dust collecting part of the cleaner station.

### BACKGROUND ART

In general, a cleaner refers to an electrical appliance that draws in small garbage or dust by sucking air using electricity and fills a dust bin provided in a product with the garbage or dust. Such a cleaner is generally called a vacuum cleaner.

The cleaners may be classified into a manual cleaner which is moved directly by a user to perform a cleaning operation, and an automatic cleaner which performs a cleaning operation while autonomously traveling. Depending on the shape of the cleaner, the manual cleaners may be classified into a canister cleaner, an upright cleaner, a handy cleaner, a stick cleaner, and the like.

The canister cleaners were widely used in the past as household cleaners. However, recently, there is an increasing tendency to use the handy cleaner and the stick cleaner in which a dust bin and a cleaner main body are integrally provided to improve convenience of use.

In the case of the canister cleaner, a main body and a suction port are connected by a rubber hose or pipe, and in some instances, the canister cleaner may be used in a state in which a brush is fitted into the suction port.

The handy cleaner (hand vacuum cleaner) has maximized portability and is light in weight. However, because the handy cleaner has a short length, there may be a limitation to a cleaning region. Therefore, the handy cleaner is used to clean a local place such as a desk, a sofa, or an interior of a vehicle.

A user may use the stick cleaner while standing and thus may perform a cleaning operation without bending his/her waist. Therefore, the stick cleaner is advantageous for the user to clean a wide region while moving in the region. The handy cleaner may be used to clean a narrow space, whereas the stick cleaner may be used to clean a wide space and also used to a high place that the user's hand cannot reach. Recently, modularized stick cleaners are provided, such that types of cleaners are actively changed and used to clean various places.

However, because the handy cleaner or the stick cleaner in the related art has a dust bin with a small capacity for storing collected dust, which inconveniences the user because the user needs to empty the dust bin frequently.

In addition, because the dust scatters during the process of emptying the dust bin, there is a problem in that the scattering dust has a harmful effect on the user's health.

In addition, if residual dust is not removed from the dust bin, there is a problem in that a suction force of the cleaner deteriorates.

In addition, if the residual dust is not removed from the dust bin, there is a problem in that the residual dust causes an offensive odor.

As a document in the related art, Korean Patent No. 10-2315412 B1 discloses a cleaning apparatus including a vacuum cleaner and a docking station and a method of controlling the same.

The cleaning apparatus disclosed in the above-mentioned document in the related art includes the vacuum cleaner including a dust collecting container, and the docking station connected to the dust collecting container, and the dust collecting container is provided to be docked to the docking station. The docking station includes a control unit configured to irregularly change a suction airflow to be supplied to the dust collecting container.

However, in the cleaning apparatus in the above-mentioned document in the related art, a state in which foreign substances are captured in a capturing part may be maintained over a long period of time, which may cause offensive odors and the growth of insects, microorganisms, and the like. In particular, mites such as grain mites are microorganisms that live on insufficiently dried grain as parasites. In case that grain is captured in the capturing part in a high-temperature, humid environment, there is a problem in that the grain mites may easily grow, move along a flow path of the docking station to the outside.

Meanwhile, in the above-mentioned document in the related art, a flow rate adjustment device may be provided. The flow rate adjustment device is configured to increase a dust collecting force by increasing a flow rate in the dust collecting container by additionally supplying air into the dust collecting container of the cleaner. However, the flow rate adjustment device does not have an effect of maintaining a clean, hygienic state by drying an interior of the dust collecting part.

### DISCLOSURE

### Technical Problem

The present disclosure has been made in an effort to solve the above-mentioned problem with a cleaner station in the related art, and an object of the present disclosure is to provide a cleaner station capable of removing dust in a dust bin without a user's separate operation, thereby providing convenience for the user.

The present disclosure has also been made in an effort to provide a cleaner station capable of maintaining a clean, hygienic state of an interior of a dust collecting part in which dust is captured.

The present disclosure has also been made in an effort to provide a cleaner station capable of preventing the occurrence of offensive odors caused by the decay of foreign substances and the like in a dust collecting part.

The present disclosure has also been made in an effort to provide a cleaner station capable of preventing the growth of insects and microorganisms such as grain mites in a dust collecting part.

### Technical Solution

In order to achieve the above-mentioned objects, the present disclosure provides a cleaner station including: a housing; a coupling part disposed in the housing and including a coupling surface to which at least a part of a cleaner is coupled; a suction flow path having one end connected to a dust passage hole formed in the coupling surface; a dust collecting part connected to the other end of the suction flow path and including a dust bag configured to capture dust in a dust bin of the cleaner, and a dust collecting chamber configured to accommodate the dust bag; and a drying part configured to dry an interior of the dust bag by generating an airflow to be introduced into the dust bag in the dust collecting chamber.

The drying part may include: an air inlet port configured to allow an interior of the dust collecting chamber and the outside of the housing to communicate with each other; a blower fan configured to introduce air present outside the housing into the dust collecting chamber through the air inlet port; and a shutter configured to open or close the air inlet port.

The drying part may include a heater configured to heat air introduced into the dust collecting chamber by the blower fan.

The blower fan may introduce air into the dust collecting chamber in a state in which the shutter opens the air inlet port.

The drying part may include a blower fan disposed in the dust collecting chamber and configured to circulate air inside the dust bag and outside air by generating an airflow that passes through the dust bag.

The drying part may include a heater configured to heat the air that circulates through the inside and outside of the dust bag by the blower fan.

The drying part may include: an air inlet port configured to allow the interior of the dust bag to communicate with an intermediate space defined between an outer peripheral surface of the dust bag and an inner peripheral surface of the dust collecting chamber; a blower fan configured to introduce air in the intermediate space into the dust bag through the air inlet port; and a shutter configured to open or close the air inlet port.

The drying part may include a heater configured to heat air introduced into the dust bag by the blower fan.

The blower fan may introduce air into the dust bag in a state in which the shutter opens the air inlet port.

A discharge flow path may be provided at one side of the dust collecting chamber and guide at least a part of air, which flows in the dust collecting chamber, to the outside of the housing.

A flow path cover configured to open or close the suction flow path may be provided at one side of the suction flow path.

The drying part may generate an airflow to be introduced into the dust bag in the dust collecting chamber in a state in which the flow path cover closes the suction flow path.

In order to achieve the above-mentioned objects, the present disclosure provides a cleaner station including: a housing; a coupling part disposed in the housing and including a coupling surface to which at least a part of a cleaner is coupled; a suction flow path having one end connected to a dust passage hole formed in the coupling surface; a dust collecting part connected to the other end of the suction flow path and including a dust bag configured to capture dust in a dust bin of the cleaner, and a dust collecting chamber configured to accommodate the dust bag; and a heater disposed in the dust collecting chamber.

### Advantageous Effects

According to the cleaner station according to the present disclosure, it is possible to eliminate the inconvenience caused because the user needs to empty the dust bin all the time.

In addition, it is possible to maintain a clean, hygienic state of the interior of the dust collecting part by supplying the hot air into the dust collecting part.

In addition, it is possible to maintain a clean, hygienic state of the interior of the dust collecting part by circulating the air inside the dust collecting part and outside air.

In addition, it is possible to prevent the occurrence of offensive odors by drying the interior of the dust collecting part.

In addition, it is possible to kill insects and microorganisms introduced into the dust bin of the cleaner by drying the interior of the dust collecting part.

### DESCRIPTION OF DRAWINGS

FIG. 1 is a perspective view of a cleaner system including a cleaner station and a cleaner according to an embodiment of the present disclosure.

FIG. 2 is a schematic view illustrating a configuration of the cleaner system according to the embodiment of the present disclosure.

FIGS. 3 and 4 are views for explaining the cleaner of the cleaner system according to the embodiment of the present disclosure.

FIG. 5 is a view for explaining a lower side of a dust bin of the cleaner according to the embodiment of the present disclosure.

FIG. 6 is a view for explaining a coupling part of the cleaner station according to the embodiment of the present disclosure.

FIG. 7 is an exploded perspective view for explaining a fixing unit of the cleaner station according to the embodiment of the present disclosure.

FIGS. 8 and 9 are views for explaining a relationship between the cleaner and a door unit in the cleaner station according to the embodiment of the present disclosure.

FIG. 10 is a view for explaining a relationship between the cleaner and a cover opening unit in the cleaner station according to the embodiment of the present disclosure.

FIG. 11 is a view for explaining of a cleaner station according to a first embodiment of the present disclosure.

FIG. 12 is a view illustrating a state in which a shutter in FIG. 11 is opened.

FIG. 13 is a view for explaining a cleaner station according to a second embodiment of the present disclosure.

FIG. 14 is a view illustrating a state in which a shutter in FIG. 13 is opened.

FIG. 15 is a view for explaining a cleaner station according to a third embodiment of the present disclosure.

FIG. 16 is a view for explaining a cleaner station according to a fourth embodiment of the present disclosure.

FIG. 17 is a view for explaining a cleaner station according to a fifth embodiment of the present disclosure.

FIG. 18 is a view illustrating a state in which a shutter in FIG. 17 is opened.

FIG. 19 is a view for explaining a cleaner station according to a sixth embodiment of the present disclosure.

FIG. 20 is a view illustrating a state in which a shutter in FIG. 19 is opened.

FIG. 21 is a view for explaining a cleaner station according to a seventh embodiment of the present disclosure.

FIG. 22 is a block diagram for explaining a control configuration of the cleaner station according to the embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

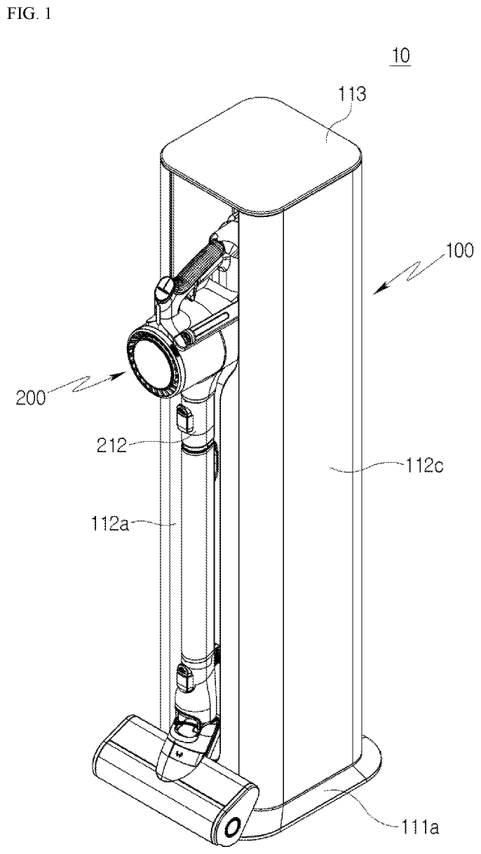

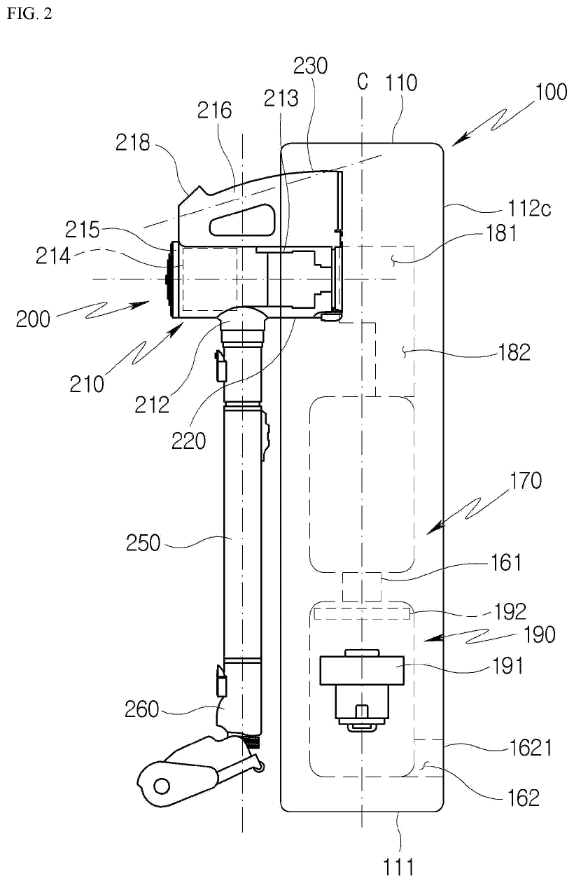

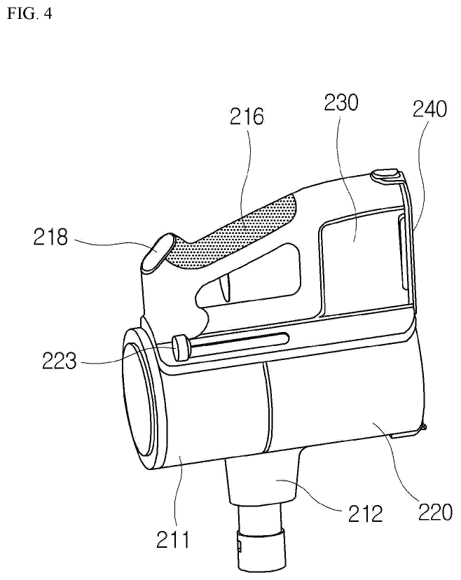

FIG. 1 is a perspective view illustrating a cleaner system including a cleaner station and a cleaner according to an embodiment of the present disclosure, and FIGS. 2 and 4 are schematic views illustrating configurations of the cleaner system according to various embodiments of the present disclosure.

With reference to FIGS. 1 and 2, a cleaner system 10 according to an embodiment of the present disclosure may include a cleaner station 100 and a cleaner 200.

The cleaner system 10 may include the cleaner station 100. The cleaner 200 may be coupled to the cleaner station 100. Specifically, a main body of the cleaner 200 may be coupled to a lateral surface of the cleaner station 100. The cleaner station 100 may remove dust from a dust bin 220 of the cleaner 200.

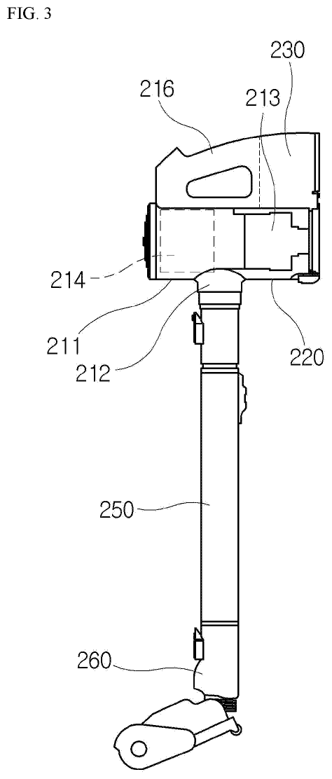

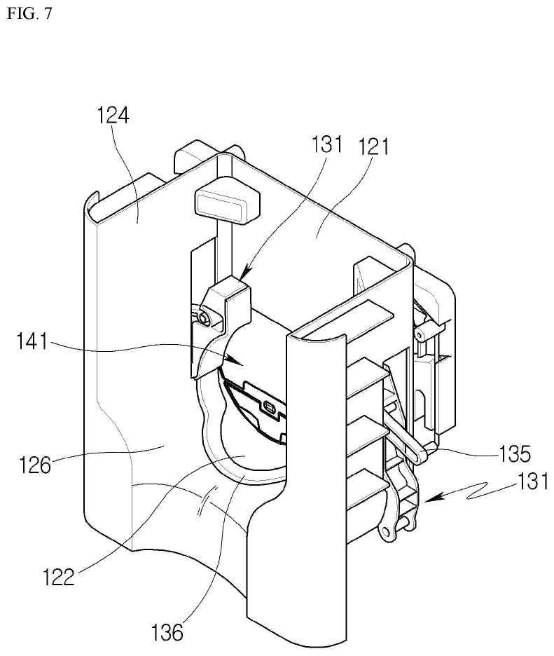

Meanwhile, FIGS. 3 and 4 are views for explaining the cleaner of the cleaner system according to the embodiment of the present disclosure, and FIG. 7 is a view for explaining the lower side of the dust bin of the cleaner according to the embodiment of the present disclosure.

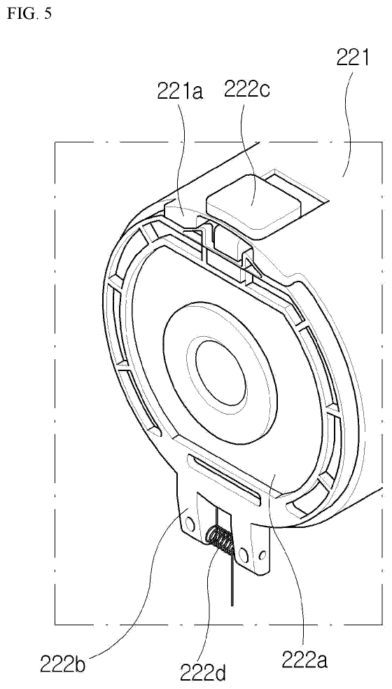

First, a structure of the cleaner 200 will be described below with reference to FIGS. 1 to 5.

The cleaner 200 may mean a cleaner configured to be manually operated by the user. For example, the cleaner 200 may mean a handy cleaner or a stick cleaner.

The cleaner 200 may be mounted on the cleaner station 100. The cleaner 200 may be supported by the cleaner station 100. The cleaner 200 may be coupled to the cleaner station 100.

Meanwhile, in the embodiment of the present disclosure, directions of the cleaner 200 may be defined on the basis of when a bottom surface (lower surface) of the dust bin 220 and a bottom surface (lower surface) of a battery housing 230 are placed on the ground surface.

In this case, a forward direction may mean a direction in which a suction part 212 is disposed based on a suction motor 214, and a rearward direction may mean a direction in which a handle 216 is disposed based on the suction motor 214. Further, based on a state in which the suction part 212 is viewed from the suction motor 214, a rightward direction may refer to a direction in which a component is disposed at the right, and a left direction may refer to a direction in which a component is disposed at the left. In addition, in the embodiment of the present disclosure, upper and lower sides may be defined in a direction perpendicular to the ground surface based on the state in which the bottom surface (lower surface) of the dust bin 220 and the bottom surface (lower surface) of the battery housing 230 are placed on the ground surface.

The cleaner 200 may include a main body 210. The main body 210 may include a main body housing 211, the suction part 212, a dust separating part 213, the suction motor 214, an air discharge cover 215, the handle 216, and an operating part 218.

The main body housing 211 may define an external appearance of the cleaner 200. The main body housing 211 may provide a space that may accommodate the suction motor 214 and a filter (not illustrated) therein. The main body housing 211 may be formed in a shape similar to a cylindrical shape.

The suction part 212 may protrude outward from the main body housing 211. For example, the suction part 212 may be formed in a cylindrical shape with an opened inside. The suction part 212 may be coupled to an extension tube 250. The suction part 212 may provide a flow path in which air containing dust may flow.

Meanwhile, in the present embodiment, an imaginary line may be defined to penetrate the inside of the suction part 212 having a cylindrical shape.

The dust separating part 213 may communicate with the suction part 212. The dust separating part 213 may separate dust sucked into the dust separating part 213 through the suction part 212. A space in the dust separating part 213 may communicate with a space in the dust bin 220.

For example, the dust separating part 213 may have one or more cyclone parts capable of separating dust by using a cyclone flow. Further, the space in the dust separating part 213 may communicate with the suction part 212. Therefore, air and dust, which are sucked through the suction part 212, spirally flow along an inner circumferential surface of the dust separating part 213. Therefore, the cyclone flow may be generated in an internal space of the dust separating part 213.

The dust separating part 213 communicates with the suction part 212. The dust separating part 213 adopts a principle of a dust collector using a centrifugal force to separate the dust sucked into the main body 210 through the suction part 212.

The dust separating part 213 may further include a secondary cyclone part configured to separate again dust from the air discharged from the cyclone part. In this case, the secondary cyclone part may be positioned in the cyclone part to minimize a size of the dust separating part. The secondary cyclone part may include a plurality of cyclone bodies disposed in parallel. The air discharged from the cyclone part may be distributed to and pass through the plurality of cyclone bodies.

In this case, an axis of a cyclone flow of the secondary cyclone part may also extend in an upward/downward direction. The axis of the cyclone flow of the cyclone part and the axis of the cyclone flow of the secondary cyclone part may be disposed coaxially in the upward/downward direction and collectively called an axis of the cyclone flow of the dust separating part 213.

The suction motor 214 may generate a suction force for sucking air. The suction motor 214 may be accommodated in the main body housing 211. The suction motor 214 may generate the suction force while rotating. For example, the suction motor 214 may be formed in a shape similar to a cylindrical shape.

Meanwhile, in the present embodiment, an imaginary suction motor axis may be formed by extending a rotation axis of the suction motor 214.

The air discharge cover 215 may be disposed at one side of the main body housing 211 based on an axial direction. The air discharge cover 215 may accommodate the filter for filtering air. For example, an HEPA filter may be accommodated in the air discharge cover 215.

The air discharge cover 215 may have an air discharge port 215a for discharging the air introduced by the suction force of the suction motor 214.

A flow guide may be disposed on the air discharge cover 215. The flow guide may guide a flow of the air to be discharged through the air discharge port 215a.

The handle 216 may be gripped by the user. The handle 216 may be disposed rearward of the suction motor 214. For example, the handle 216 may be formed in a shape similar to a cylindrical shape. Alternatively, the handle 216 may be formed in a curved cylindrical shape. The handle 216 may be disposed at a predetermined angle with respect to the main body housing 211, the suction motor 214, or the dust separating part 213.

The handle 216 may include a grip portion formed in a column shape so that the user may grasp the grip portion, a first extension portion connected to one end of the grip portion based on the longitudinal direction (axial direction) of the grip portion and extending toward the suction motor 214, and a second extension portion connected to the other end of the grip portion based on the longitudinal direction (axial direction) of the grip portion and extending toward the dust bin 220.

Meanwhile, in the present embodiment, an imaginary grip portion through line may be formed to extend in the longitudinal direction of the grip portion (the axial direction of the column) and penetrate the grip portion.

For example, the grip portion through line may be an imaginary line formed in the handle 216 having a cylindrical shape, that is, an imaginary line formed in parallel with at least a part of an outer surface (outer circumferential surface) of the grip portion.

An upper side of the handle 216 may define an external appearance of a part of an upper side of the cleaner 200. Therefore, it is possible to prevent a component of the cleaner 200 from coming into contact with the user's arm when the user grips the handle 216.

The first extension portion may extend from the grip portion toward the main body housing 211 or the suction motor 214. At least a part of the first extension portion may extend in a horizontal direction.

The second extension portion may extend from the grip portion toward the dust bin 220. At least a part of the second extension portion may extend in the horizontal direction.

The operating part 218 may be disposed on the handle 216. The operating part 218 may be disposed on an inclined surface formed in an upper region of the handle 216. The user may input a command for operating or stopping the cleaner 200 through the operating part 218.

The cleaner 200 may include the dust bin 220. The dust bin 220 may communicate with the dust separating part 213. The dust bin 220 may store the dust separated by the dust separating part 213.

The dust bin 220 may include a dust bin main body 221, a discharge cover 222, a dust bin compression lever 223, and a compression member (not illustrated).

The dust bin main body 221 may provide a space capable of storing the dust separated by the dust separating part 213. For example, the dust bin main body 221 may be formed in a shape similar to a cylindrical shape.

Meanwhile, in the present embodiment, an imaginary dust bin through line may be formed to penetrate the inside (internal space) of the dust bin main body 221 and extend in the longitudinal direction of the dust bin main body 221 (that means the axial direction of the cylindrical dust bin main body 221).

A part of a lower side (bottom side) of the dust bin main body 221 may be opened. In addition, a lower extension portion 221a may be formed at the lower side (bottom side) of the dust bin main body 221. The lower extension portion 221a may be formed to block a part of the lower side of the dust bin main body 221.

The dust bin 220 may include the discharge cover 222. The discharge cover 222 may be disposed at a lower side of the dust bin 220.

The discharge cover 222 may be provided to open or close one end of the dust bin main body 221 based on the longitudinal direction. Specifically, the discharge cover 222 may selectively open or close the lower side of the dust bin 220 that is opened downward.

The discharge cover 222 may include a cover main body 222a and a hinge part 222b. The cover main body 222a may be formed to block a part of the lower side of the dust bin main body 221. The cover main body 222a may rotate downward relative to the hinge portion 222b. The hinge part 222b may be disposed adjacent to the battery housing 230. The hinge part 222b may have a torsion spring 222d. Therefore, when the discharge cover 222 is separated from the dust bin main body 221, an elastic force of the torsion spring 222d may support the cover main body 222a in a state in which the cover main body 222a is rotated by a predetermined angle or more about the hinge part 222b with respect to the dust bin main body 221.

The discharge cover 222 may be coupled to the dust bin 220 by a hook engagement. Meanwhile, the discharge cover 222 may be separated from the dust bin 220 by means of a coupling lever 222c. The coupling lever 222c may be disposed at a front side of the dust bin. Specifically, the coupling lever 222c may be disposed on an outer surface at the front side of the dust bin 220. When an external force is applied, the coupling lever 222c may elastically deform a hook, which extends from the cover main body 222a, in order to release the hook engagement between the cover main body 222a and the dust bin main body 221.

When the discharge cover 222 is closed, the lower side of the dust bin 220 may be blocked (sealed) by the discharge cover 222 and the lower extension portion 221a.

The dust bin 220 may include the dust bin compression lever 223 (see FIG. 4). The dust bin compression lever 223 may be disposed outside the dust bin 220 or the dust separating part 213. The dust bin compression lever 223 may be disposed outside the dust bin 220 or the dust separating part 213 so as to be movable upward and downward. The dust bin compression lever 223 may be connected to the compression member (not illustrated). When the dust bin compression lever 223 is moved downward by an external force, the compression member (not illustrated) may also be moved downward. Therefore, it is possible to provide convenience for the user. The compression member (not illustrated) and the dust bin compression lever 223 may return back to original positions by an elastic member (not illustrated). Specifically, when the external force applied to the dust bin compression lever 223 is eliminated, the elastic member may move the dust bin compression lever 223 and the compression member (not illustrated) upward.

The compression member (not illustrated) may be disposed in the dust bin main body 221. The compression member may move in the internal space of the dust bin main body 221. Specifically, the compression member may move upward and downward in the dust bin main body 221. Therefore, the compression member may compress downward the dust in the dust bin main body 221. In addition, when the discharge cover 222 is separated from the dust bin main body 221 and thus the lower side of the dust bin 220 is opened, the compression member may move from an upper side of the dust bin 220 to the lower side of the of the dust bin 220, thereby removing debris such as residual dust in the dust bin 220. Therefore, it is possible to improve the suction force of the cleaner by preventing the residual dust from remaining in the dust bin 220. Further, it is possible to remove an offensive odor caused by the residual dust by preventing the residual dust from remaining in the dust bin 220.

The cleaner 200 may include the battery housing 230. A battery 240 may be accommodated in the battery housing 230. The battery housing 230 may be disposed below the handle 216. For example, the battery housing 230 may have a hexahedral shape opened at a lower side thereof. A rear side of the battery housing 230 may be connected to the handle 216.

The battery housing 230 may include an accommodation portion opened downward. The battery 240 may be attached or detached through the accommodation portion of the battery housing 230.

The cleaner 200 may include the battery 240.

For example, the battery 240 may be separably coupled to the cleaner 200. The battery 240 may be separably coupled to the battery housing 230. For example, the battery 240 may be inserted into the battery housing 230 from the lower side of the battery housing 230. With this configuration, the portability of the cleaner 200 may be improved.

On the contrary, the battery 240 may be integrally provided in the battery housing 230. In this case, a lower surface of the battery 240 is not exposed to the outside.

The battery 240 may supply power to the suction motor 214 of the cleaner 200. The battery 240 may be disposed below the handle 216. The battery 240 may be disposed at a rear side of the dust bin 220.

In case that the battery 240 is coupled to the battery housing 230 in accordance with the embodiment, the lower surface of the battery 240 may be exposed to the outside. Because the battery 240 may be placed on the floor when the cleaner 200 is placed on the floor, the battery 240 may be immediately separated from the battery housing 230. In addition, because the lower side of the battery 240 is exposed to the outside and thus in direct contact with the air present outside the battery 240, the performance in cooling the battery 240 may be improved.

Meanwhile, in case that the battery 240 is fixed integrally to the battery housing 230, the number of structures for attaching or detaching the battery 240 and the battery housing 230 may be reduced, and as a result, it is possible to reduce an overall size of the cleaner 200 and a weight of the cleaner 200.

The cleaner 200 may include the extension tube 250. The extension tube 250 may communicate with a cleaning module 260. The extension tube 250 may communicate with the main body 210. The extension tube 250 may communicate with the suction part 212 of the main body 210. The extension tube 250 may be formed in a long cylindrical shape.

The main body 210 may be connected to the extension tube 250. The main body 210 may be connected to the cleaning module 260 through the extension tube 250. The main body 210 may generate the suction force by means of the suction motor 214 and provide the suction force to the cleaning module 260 through the extension tube 250. The outside dust may be introduced into the main body 210 through the cleaning module 260 and the extension tube 250.

The cleaner 200 may include the cleaning module 260. The cleaning module 260 may communicate with the extension tube 250. Therefore, the outside air may be introduced into the main body 210 of the cleaner 200 via the cleaning module 260 and the extension tube 250 by the suction force generated in the main body 210 of the cleaner 200.

The dust in the dust bin 220 of the cleaner 200 may be captured by a dust collecting part 170 of the cleaner station 100 by gravity and a suction force of a dust collecting motor 191. Therefore, it is possible to remove the dust in the dust bin without the user's separate manipulation, thereby providing convenience for the user. In addition, it is possible to eliminate the inconvenience of the user having to empty the dust bin all the time. In addition, it is possible to prevent the dust from scattering when emptying the dust bin.

The cleaner 200 may be coupled to a lateral surface of a housing 110. Specifically, the main body 210 of the cleaner 200 may be mounted on a coupling part 120. More specifically, the dust bin 220 and the battery housing 230 of the cleaner 200 may be coupled to a coupling surface 121, an outer circumferential surface of the dust bin main body 221 may be coupled to a dust bin guide surface 122, and the suction part 212 may be coupled to a suction part guide surface 126 of the coupling part 120. In this case, a central axis of the dust bin 220 may be disposed in a direction parallel to the ground surface, and the extension tube 250 may be disposed in a direction perpendicular to the ground surface.

The cleaner station 100 of the present disclosure will be described below with reference to FIGS. 1 and 2.

The cleaner 200 may be disposed in the cleaner station 100. The cleaner 200 may be coupled to a lateral side of the cleaner station 100. Specifically, the main body of the cleaner 200 may be coupled to the lateral surface of the cleaner station 100. The cleaner station 100 may remove dust from the dust bin 220 of the cleaner 200.

The cleaner station 100 may include the housing 110. The housing 110 may define an external appearance of the cleaner station 100. Specifically, the housing 110 may be provided in the form of a column including one or more outer wall surfaces. For example, the housing 110 may be formed in a shape similar to a quadrangular column.

The housing 110 may have a space capable of accommodating the dust collecting part 170 configured to store dust therein, and a dust suction module 190 configured to generate a flow force for collecting the dust in the dust collecting part 170.

The housing 110 may include a bottom surface 111, an outer wall surface 112, and an upper surface 113.

The bottom surface 111 may support a lower side of the dust suction module 190 based on the gravitational direction. That is, the bottom surface 111 may support a lower side of the dust collecting motor 191 of the dust suction module 190.

In this case, the bottom surface 111 may be disposed toward the ground surface. The bottom surface 111 may also be disposed in parallel with the ground surface or disposed to be inclined at a predetermined angle with respect to the ground surface. The above-mentioned configuration may be advantageous in stably supporting the dust collecting motor 191 and maintaining balance of an overall weight even in a case in which the cleaner 200 is coupled.

Meanwhile, according to the embodiment, the bottom surface 111 may further include a ground surface support portion 111a in order to prevent the cleaner station 100 from falling down and increase an area being in contact with the ground surface to maintain the balance. For example, the ground surface support portion may have a plate shape extending from the bottom surface 111, and one or more frames may protrude and extend from the bottom surface 111 in a direction of the ground surface.

The outer wall surface 112 may mean a surface formed in the gravitational direction or a surface connected to the bottom surface 111. For example, the outer wall surface 112 may mean a surface connected to the bottom surface 111 so as to be perpendicular to the bottom surface 111. As another embodiment, the outer wall surface 112 may be disposed to be inclined at a predetermined angle with respect to the bottom surface 111.

The outer wall surface 112 may include at least one surface. For example, the outer wall surface 112 may include a first outer wall surface 112a, a second outer wall surface 112b, a third outer wall surface 112c, and a fourth outer wall surface 112d.

In this case, in the present embodiment, the first outer wall surface 112a may be disposed at the front side of the cleaner station 100. In this case, the front side may mean a side at which the cleaner 200 is exposed in the state in which the cleaner 200 is coupled to the cleaner station 100. Therefore, the first outer wall surface 112a may define an external appearance of the front side of the cleaner station 100.

Meanwhile, the directions are defined as follows to understand the present embodiment. In the present embodiment, the directions may be defined in the state in which the cleaner 200 is mounted on the cleaner station 100.

In the state in which the cleaner 200 is mounted on the cleaner station 100, a direction in which the cleaner 200 is exposed to the outside of the cleaner station 100 may be referred to as a forward direction.

In another point of view, in the state in which the cleaner 200 is mounted on the cleaner station 100, a direction in which the suction motor 214 of the cleaner 200 is disposed may be referred to as the forward direction. Further, a direction opposite to the direction in which the suction motor 214 is disposed on the cleaner station 100 may be referred to as a rearward direction.

Further, based on the internal space of the housing 110, a surface facing the front surface may be referred to as a rear surface of the cleaner station 100. Therefore, the rear surface may mean a direction in which the second outer wall surface 112b is formed.

Further, based on the internal space of the housing 110, a left surface when viewing the front surface may be referred to as a left surface, and a right surface when viewing the front surface may be referred to as a right surface. Therefore, the left surface may mean a direction in which the third outer wall surface 112c is formed, and the right surface may mean a direction in which the fourth outer wall surface 112d is formed.

The first outer wall surface 112a may be formed in the form of a flat surface, or the first outer wall surface 112a may be formed in the form of a curved surface as a whole or formed to partially include a curved surface.

The first outer wall surface 112a may have an external appearance corresponding to the shape of the cleaner 200. In detail, the coupling part 120 may be disposed on the first outer wall surface112a. With this configuration, the cleaner 200 may be coupled to the cleaner station 100 and supported by the cleaner station 100. The specific configuration of the coupling part 120 will be described below.

Meanwhile, a structure for mounting various types of cleaning modules 260 used for the cleaner 200 may be additionally provided on the first outer wall surface 112a.

In the present embodiment, the second outer wall surface 112b may be a surface facing the first outer wall surface 112a. That is, the second outer wall surface 112b may be disposed on the rear surface of the cleaner station 100. In this case, the rear surface may be a surface facing the surface to which the cleaner 200 is coupled. Therefore, the second outer wall surface 112b may define an external appearance of the rear surface of the cleaner station 100.

For example, the second outer wall surface 112b may be formed in the form of a flat surface. With this configuration, the cleaner station 100 may be in close contact with a wall in a room, and the cleaner station 100 may be stably supported.

As another example, the structure for mounting various types of cleaning modules 260 used for the cleaner 200 may be additionally provided on the second outer wall surface 112b.

In the present embodiment, the third outer wall surface 112c and the fourth outer wall surface 112d may mean surfaces that connect the first outer wall surface 112a and the second outer wall surface 112b. In this case, the third outer wall surface 112c may be disposed on the left surface of the station 100, and the fourth outer wall surface 112d may be disposed on the right surface of the cleaner station 100. On the contrary, the third outer wall surface 112c may be disposed on the right surface of the cleaner station 100, and the fourth outer wall surface 112d may be disposed on the left surface of the cleaner station 100.

The third outer wall surface 112c or the fourth outer wall surface 112d may be formed in the form of a flat surface, or the third outer wall surface 112c or the fourth outer wall surface 112d may be formed in the form of a curved surface as a whole or formed to partially include a curved surface.

Meanwhile, the structure for mounting various types of cleaning modules 260 used for the cleaner 200 may be additionally provided on the third outer wall surface 112c or the fourth outer wall surface 112d.

The upper surface 113 may define an upper external appearance of the cleaner station. That is, the upper surface 113 may mean a surface disposed at an outermost side of the cleaner station in the gravitational direction and exposed to the outside.

For reference, in the present embodiment, the terms ‘upper side’ and ‘lower side’ may mean the upper and lower sides in the gravitational direction (a direction perpendicular to the ground surface) in the state in which the cleaner station 100 is installed on the ground surface.

In this case, the upper surface 113 may also be disposed in parallel with the ground surface or disposed to be inclined at a predetermined angle with respect to the ground surface.

A display part 410 may be disposed on the upper surface 113. For example, the display part 410 may display a state of the cleaner station 100 and a state of the cleaner 200. The display part may further display information such as a cleaning process situation, a map of the cleaning zone, and the like.

Meanwhile, according to the embodiment, the upper surface 113 may be separable from the outer wall surface 112. In this case, when the upper surface 113 is separated, the battery separated from the cleaner 200 may be accommodated in the internal space surrounded by the outer wall surface 112, and a terminal (not illustrated) capable of charging the separated battery may be provided in the internal space.

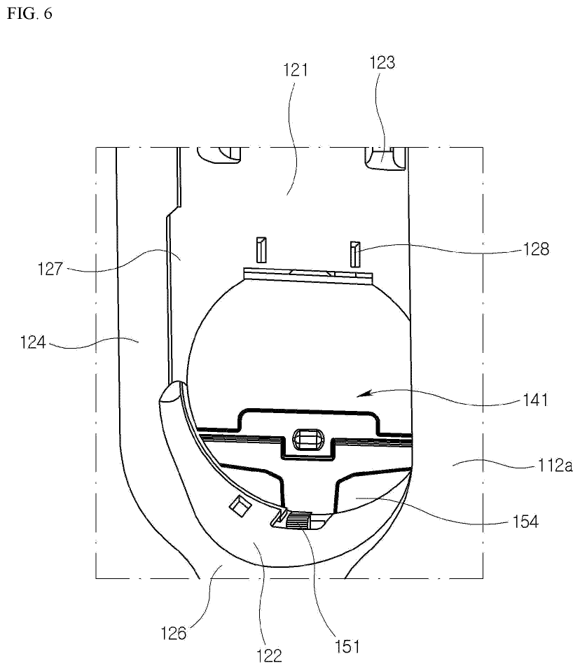

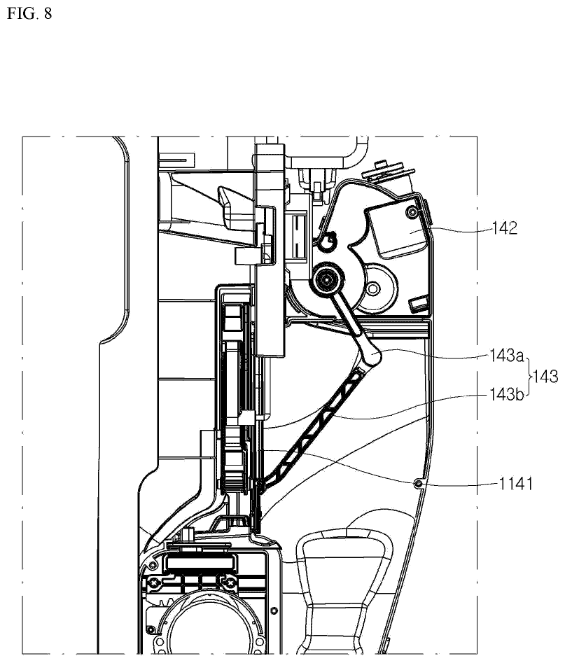

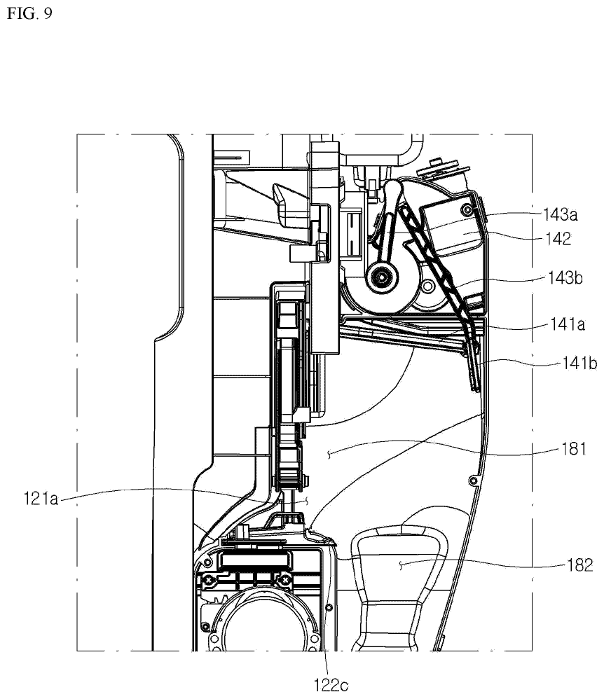

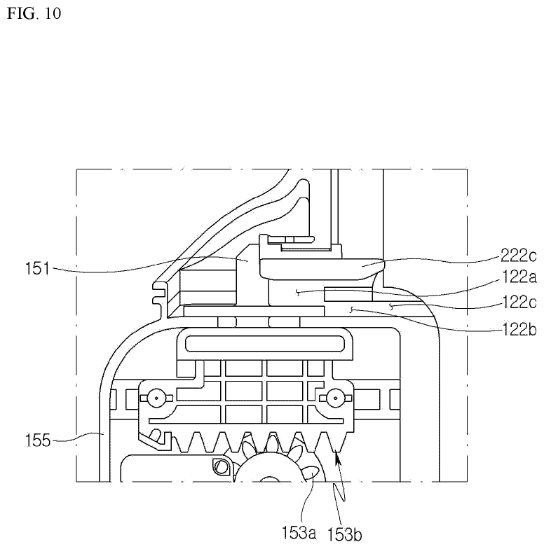

FIG. 6 is a view for explaining the coupling part of the cleaner station according to the embodiment of the present disclosure, FIG. 7 is a view for explaining a fixing unit of the cleaner station according to the embodiment of the present disclosure, FIGS. 8 and 9 are views for explaining a relationship between the cleaner and a door unit in the cleaner station according to the embodiment of the present disclosure, and FIG. 10 is a view for explaining a relationship between the cleaner and a cover opening unit in the cleaner station according to the embodiment of the present disclosure.

The coupling part 120 of the cleaner station 100 according to the present disclosure will be described below with reference to FIGS. 2 and 6.

The cleaner station 100 may include the coupling part 120 to which the cleaner 200 is coupled. Specifically, the coupling part 120 may be disposed in the first outer wall surface 112a, and the main body 210, the dust bin 220, and the battery housing 230 of the cleaner 200 may be coupled to the coupling part 120.

The coupling part 120 may include the coupling surface 121. The coupling surface 121 may be disposed on the lateral surface of the housing 110. For example, the coupling surface 121 may mean a surface formed in the form of a groove which is concave toward the inside of the cleaner station 100 from the first outer wall surface 112a. That is, the coupling surface 121 may mean a surface formed to have a stepped portion with respect to the first outer wall surface 112a.

The cleaner 200 may be coupled to the coupling surface 121. For example, the coupling surface 121 may be in contact with the lower surface of the dust bin 220 and the lower surface of the battery housing 230 of the cleaner 200. In this case, the lower surface may mean a surface directed toward the ground surface when the user uses the cleaner 200 or places the cleaner 200 on the ground surface.

For example, an angle of the coupling surface 121 with respect to the ground surface may be a right angle. Therefore, it is possible to minimize a space of the cleaner station 100 when the cleaner 200 is coupled to the coupling surface 121.

As another example, the coupling surface 121 may be disposed to be inclined at a predetermined angle with respect to the ground surface. Therefore, the cleaner station 100 may be stably supported when the cleaner 200 is coupled to the coupling surface 121.

The coupling part 120 may have a dust passage hole 121a through which air present outside the housing 110 may be introduced into the housing 110. Specifically, the dust passage hole 121a may be formed in the coupling surface 121 of the coupling part 120 so that outside air may be introduced into the housing 110. The dust passage hole 121a may be formed in the coupling surface 121 so that outside air may be introduced into the housing 110. The dust passage hole 121a may be formed in the form of a hole corresponding to the shape of the dust bin 220 so that the dust in the dust bin 220 may be introduced into the dust collecting part 170. The dust passage hole 121a may be formed to correspond to the shape of the discharge cover 222 of the dust bin 220. The dust passage hole 121a may be formed to communicate with a suction flow path 180 to be described below.

The coupling part 120 may include the dust bin guide surface 122. The dust bin guide surface 122 may be disposed on the first outer wall surface 112a. The dust bin guide surface 122 may be connected to the first outer wall surface 112a. In addition, the dust bin guide surface 122 may be connected to the coupling surface 121.

The dust bin guide surface 122 may be formed in a shape corresponding to the outer surface of the dust bin 220. A front outer surface of the dust bin 220 may be coupled to the dust bin guide surface 122. Therefore, it is possible to provide the convenience when coupling the cleaner 200 to the coupling surface 121.

Meanwhile, a protrusion moving hole 122a may be formed in the dust bin guide surface 122, and a push protrusion 151 to be described below may rectilinearly move along the protrusion moving hole 122a. In addition, a gearbox 155 may be provided below the dust bin guide surface 122 based on the gravitational direction and accommodate a gear or the like of a cover opening unit 150 to be described below. In this case, a guide space 122b, through which the push protrusion 151 may move, may be formed between the dust bin guide surface 122, the lower surface, and the upper surface of the gearbox 155. Further, the guide space 122b may communicate with the suction flow path 180 through a bypass hole 122c. That is, the protrusion moving hole 122a, the guide space 122b, the bypass hole 122c, and the suction flow path 180 may define one bypass flow path (see FIG. 10). With this configuration, when the dust collecting motor 191 operates in the state in which the dust bin 220 is coupled to the coupling part 120, the dust or the like, which remains in the dust bin 220 and remains on the dust bin guide surface 122, may be sucked through the bypass flow path.

The coupling part 120 may include guide protrusions 123. The guide protrusions 123 may be disposed on the coupling surface 121. The guide protrusions 123 may protrude upward from the coupling surface 121. Two guide protrusions 123 may be disposed to be spaced apart from each other. A distance between the two guide protrusions 123, which are spaced apart from each other, may correspond to a width of the battery housing 230 of the cleaner 200. Therefore, it is possible to provide the convenience when coupling the cleaner 200 to the coupling surface 121.

The coupling part 120 may include sidewalls 124. The sidewalls 124 may mean wall surfaces disposed at two opposite sides of the coupling surface 121 and may be perpendicularly connected to the coupling surface 121. The sidewalls 124 may be connected to the first outer wall surface 112a. In addition, the sidewalls 124 may define surfaces connected to the dust bin guide surface 122. Therefore, the cleaner 200 may be stably accommodated.

The coupling part 120 may include a coupling sensor 125. The coupling sensor 125 may detect whether the cleaner 200 is coupled to the coupling part 120.

The coupling sensor 125 may include a contact sensor. For example, the coupling sensor 125 may include a micro-switch. In this case, the coupling sensor 125 may be disposed on the guide protrusion 123. Therefore, when the battery housing 230 or the battery 240 of the cleaner 200 is coupled between the pair of guide protrusions 123, the battery housing 230 or the battery 240 comes into contact with the coupling sensor 125, such that the coupling sensor 125 may detect that the cleaner 200 is coupled to the coupling part.

Meanwhile, the coupling sensor 125 may include a contactless sensor. For example, the coupling sensor 125 may include an infrared ray (IR) sensor. In this case, the coupling sensor 125 may be disposed on the sidewall 124. Therefore, when the dust bin 220 or the main body 210 of the cleaner 200 passes the sidewall 124 and then reaches the coupling surface 121, the coupling sensor 125 may detect the presence of the dust bin 220 or the main body 210.

The coupling sensor 125 may face the dust bin 220 or the battery housing 230 of the cleaner 200.

The coupling sensor 125 may be a mean for determining whether the cleaner 200 is coupled and power is applied to the battery 240 of the cleaner 200.

The coupling part 120 may include the suction part guide surface 126. The suction part guide surface 126 may be disposed on the first outer wall surface 112a. The suction part guide surface 126 may be connected to the dust bin guide surface 122. The suction part 212 may be coupled to the suction part guide surface 126. The suction part guide surface 126 may be formed in a shape corresponding to the shape of the suction part 212.

The coupling part 120 may further include a fixing member entrance hole 127. The fixing member entrance hole 127 may be formed in the form of a long hole along the sidewall 124 so that fixing members 131 may enter and exit the fixing member entrance hole 127.

With this configuration, when the user couples the cleaner 200 to the coupling part 120 of the cleaner station 100, the main body 210 of the cleaner 200 may be stably disposed on the coupling part 120 by the dust bin guide surface 122, the guide protrusions 123, and the suction part guide surface 126. Therefore, it is possible to provide convenience when coupling the dust bin 220 and the battery housing 230 of the cleaner 200 to the coupling surface 121.

A fixing unit 130 according to the present disclosure will be described below with reference to FIGS. 2 and 7.

The cleaner station 100 according to the present disclosure may include the fixing unit 130. The fixing unit 130 may be disposed on the sidewall 124. In addition, at least a part of the fixing unit 130 may be disposed on a back surface to the coupling surface 121. The fixing unit 130 may fix the cleaner 200 coupled to the coupling surface 121. Specifically, the fixing unit 130 may fix the dust bin 220 and the battery housing 230 of the cleaner 200 coupled to the coupling surface 121.

The fixing unit 130 may include a fixing members 131 configured to fix the dust bin 220 and the battery housing 230 of the cleaner 200, and a fixing part motor 133 configured to operate the fixing members 131. In addition, the fixing unit 130 may further include fixing part links 135 configured to transmit power of the fixing part motor 133 to the fixing members 131.

The fixing members 131 may be disposed on the sidewall 124 of the coupling part 120 and provided on the sidewall 124 so as to reciprocate in order to fix the dust bin 220. Specifically, the fixing members 131 may be accommodated in the fixing member entrance hole 127.

The fixing members 131 may be disposed at two opposite sides of the coupling part 120, respectively. For example, a pair of two fixing members 131 may be symmetrically disposed with respect to the coupling surface 121.

The fixing part motor 133 may provide power for moving the fixing member 131.

The fixing part links 135 may convert a rotational force of the fixing part motor 133 into the reciprocations of the fixing members 131.

A stationary sealer 136 may be disposed on the dust bin guide surface 122 so as to seal the dust bin 220 when the cleaner 200 is coupled. With this configuration, when the dust bin 220 of the cleaner 200 is coupled, the cleaner 200 may press the stationary sealer 136 by its own weight, such that the dust bin 220 and the dust bin guide surface 122 may be sealed.

The stationary sealer 136 may be disposed on an imaginary extension line of the fixing member 131. With this configuration, when the fixing part motor 133 operates and the fixing members 131 press the dust bin 220, a circumference of the dust bin 220 at the same height may be sealed.

According to the embodiment, the stationary sealer 136 may be disposed on the dust bin guide surface 122 and formed in the form of a bent line corresponding to an arrangement of the cover opening unit 150 to be described below.

Therefore, when the main body 210 of the cleaner 200 is disposed on the coupling part 120, the fixing unit 130 may fix the main body 210 of the cleaner 200. Specifically, when the coupling sensor 125 detects that the main body 210 of the cleaner 200 is coupled to the coupling part 120 of the cleaner station 100, the fixing part motor 133 may move the fixing members 131 to fix the main body 210 of the cleaner 200.

Therefore, it is possible to improve the suction force of the cleaner by preventing the residual dust from remaining in the dust bin. Further, it is possible to remove an offensive odor caused by the residual dust by preventing the residual dust from remaining in the dust bin.

A door unit 140 according to the present disclosure will be described below with reference to FIGS. 2, 8, 9, and 22.

The cleaner station 100 according to the present disclosure may include the door unit 140. The door unit 140 may be configured to open or close the dust passage hole 121a.

The door unit 140 may include a door 141, a door motor 142, and a door arm 143.

The door 141 may be hingedly coupled to the coupling surface 121 and may open or close the dust passage hole 121a. The door 141 may include a door main body 141a.

The door main body 141a may be formed in a shape capable of blocking the dust passage hole 121a. For example, the door main body 141a may be formed in a shape similar to a circular plate shape.

Based on a state in which the door main body 141a blocks the dust passage hole 121a, the hinge part may be disposed at an upper side of the door main body 141a, and an arm coupling part 141b may be disposed at a lower side of the door main body 141a.

The door main body 141a may be formed in a shape capable of sealing the dust passage hole 121a. For example, an outer surface of the door main body 141a, which is exposed to the outside of the cleaner station 100, is formed to have a diameter corresponding to a diameter of the dust passage hole 121a, and an inner surface of the door main body 141a, which is disposed in the cleaner station 100, is formed to have a diameter greater than the diameter of the dust passage hole 121a. In addition, a level difference may be defined between the outer surface and the inner surface. Meanwhile, one or more reinforcing ribs may protrude from the inner surface of the door main body 141a in order to connect the hinge part and the arm coupling part 141b and reinforce a supporting force of the door main body 141a.

The hinge part may be a means by which the door 141 is hingedly coupled to the coupling surface 121. The hinge part may be disposed at an upper end of the door main body 141a and coupled to the coupling surface 121.

The arm coupling part 141b may be a means to which the door arm 143 is rotatably coupled. The arm coupling part 141b may be disposed at a lower side of the door main body 141a and rotatably coupled to the door main body 141a, and the door arm 143 may be rotatably coupled to the arm coupling part 141b.

With this configuration, when the door arm 143 pulls the door main body 141a in the state in which the door 141 closes the dust passage hole 121a, the door main body 141a is rotated about the hinge part toward the inside of the cleaner station 100, such that the dust passage hole 121a may be opened. Meanwhile, when the door arm 143 pushes the door main body 141a in the state in which the dust passage hole 121a is opened, the door main body 141a is rotated about the hinge part 141b toward the outside of the cleaner station 100, such that the dust passage hole 121a may be closed.

Meanwhile, the door 141 may be in contact with the discharge cover 222 in the state in which the cleaner 200 is coupled to the cleaner station 100 and the discharge cover 222 is separated from the dust bin main body 210. Further, when the door 141 rotates, the discharge cover 222 may rotate in conjunction with the door 141.

The door motor 142 may provide power for rotating the door 141. Specifically, the door motor 142 may rotate the door arm 143 in a forward or reverse direction. In this case, the forward direction may mean a direction in which the door arm 143 pulls the door 141. Therefore, when the door arm 143 is rotated in the forward direction, the dust passage hole 121a may be opened. In addition, the reverse direction may mean a direction in which the door arm 143 pushes the door 141. Therefore, when the door arm 143 is rotated in the reverse direction, at least a part of the dust passage hole 121a may be closed. The forward direction may be opposite to the reverse direction.

The door arm 143 may connect the door 141 and the door motor 142 and open or close the door 141 using the power generated from the door motor 142.

For example, the door arm 143 may include a first door arm 143a and the second door arm 143b. One end of the first door arm 143a may be coupled to the door motor 142. The first door arm 143a may be rotated by the power of the door motor 142. The other end of the first door arm 143a may be rotatably coupled to the second door arm 143b. The first door arm 143a may transmit a force transmitted from the door motor 142 to the second door arm 143b. One end of the second door arm 143b may be coupled to the first door arm 143a. The other end of the second door arm 143b may be coupled to the door 141. The second door arm 143b may open or close the dust passage hole 121a by pushing or pulling the door 141.

The door unit 140 may further include door opening/closing detecting parts 144. The door opening/closing detecting parts 144 may be provided in the housing 110 and may detect whether the door 141 is in an opened state.

For example, the door opening/closing detecting parts 144 may be disposed at both ends in a rotational region of the door arm 143, respectively. As another example, the door opening/closing detecting parts 144 may be disposed at both ends in a movement region of the door 141, respectively.

Therefore, when the door arm 143 is moved to a preset door opening position DP1 or when the door 141 is opened to a predetermined position, the door opening/closing detecting parts 144 may detect that the door is opened. In addition, when the door arm 143 is moved to a preset door closing position DP2 or when the door 141 is opened to a predetermined position, the door opening/closing detecting parts 144 may detect that the door is opened.

The door opening/closing detecting part 144 may include a contact sensor. For example, the door opening/closing detecting part 144 may include a micro-switch.

Meanwhile, the door opening/closing detecting part 144 may also include a contactless sensor. For example, the door opening/closing detecting part 144 may include an infrared ray (IR) sensor.

With this configuration, the door unit 140 may selectively open or close at least a part of the coupling surface 121, thereby allowing the outside of the first outer wall surface 112a to communicate with the suction flow path 180 and/or the dust collecting part 170.

The door unit 140 may be opened when the discharge cover 222 of the cleaner 200 is opened. In addition, when the door unit 140 is closed, the discharge cover 222 of the cleaner 200 may also be closed in conjunction with the door unit 140.

When the dust in the dust bin 220 of the cleaner 200 is removed, the door motor 142 may rotate the door 141, thereby coupling the discharge cover 222 to the dust bin main body 221. Specifically, the door motor 142 may rotate the door 141 to rotate the door 141, and the rotating door 141 may push the discharge cover 222 toward the dust bin main body 221.

The cover opening unit 150 according to the present disclosure will be described below with reference to FIGS. 2, 10, and 22.

The cleaner station 100 according to the present disclosure may include the cover opening unit 150. The cover opening unit 150 may be disposed on the coupling part 120 and may open the discharge cover 222 of the cleaner 200.

The cover opening unit 150 may include the push protrusion 151, a cover opening motor 152, cover opening gears 153, a support plate 154, and the gear box 155.

The push protrusion 151 may move to press the coupling lever 222c when the cleaner 200 is coupled.

The push protrusion 151 may be disposed on the dust bin guide surface 122. Specifically, the protrusion moving hole may be formed in the dust bin guide surface 122, and the push protrusion 151 may be exposed to the outside by passing through the protrusion moving hole.

When the cleaner 200 is coupled, the push protrusion 151 may be disposed at a position at which the push protrusion 151 may push the coupling lever 222c. That is, the coupling lever 222c may be disposed on the protrusion moving hole. In addition, the coupling lever 222c may be disposed in a movement region of the push protrusion 151.

The push protrusion 151 may rectilinearly reciprocate to press the coupling lever 222c. Specifically, the push protrusion 151 may be coupled to the gear box 155, such that the rectilinear movement of the push protrusion 151 may be guided. The push protrusion 151 may be coupled to the cover opening gears 153 and moved together with the cover opening gears 153 by the movements of the cover opening gears 153.

The cover opening motor 152 may provide power for moving the push protrusion 151. Specifically, the cover opening motor 152 may rotate a motor shaft (not illustrated) in a forward direction or a reverse direction. In this case, the forward direction may mean a direction in which the push protrusion 151 pushes the coupling lever 222c. In addition, the reverse direction may mean a direction in which the push protrusion 151, which has pushed the coupling lever 222c, returns back to an original position. The forward direction may be opposite to the reverse direction.

The cover opening gears 153 may be coupled to the cover opening motor 152 and may move the push protrusion 151 using the power from the cover opening motor 152. Specifically, the cover opening gears 153 may be accommodated in the gear box 155. A driving gear 153a of the cover opening gears 153 may be coupled to the motor shaft of the cover opening motor 152 and supplied with the power. A driven gear 153b of the cover opening gears 153 may be coupled to the push protrusion 151 to move the push protrusion 151. For example, the driven gear 153b may be provided in the form of a rack gear, engage with the driving gear 153a, and receive power from the driving gear 153a.

In this case, the discharge cover 222 may have the torsion spring 222d. The discharge cover 222 may be rotated by a predetermined angle or more and supported in the rotated position by an elastic force of the torsion spring 222d. Therefore, the discharge cover 222 may be opened, and the dust passage hole 121a and the inside of the dust bin 220 may communicate with each other.

The gear box 155 may be disposed in the housing 110 and disposed at the lower side of the coupling part 120 in the gravitational direction, and the cover opening gears 153 may be accommodated in the gear box 155.

Cover opening detecting parts 155f may be disposed on the gear box 155. In this case, the cover opening detecting part 155f may include a contact sensor. For example, the cover opening detecting part 155f may include a micro-switch. Meanwhile, the cover opening detecting part 155f may also include a contactless sensor. For example, the cover opening detecting part 155f may include an infrared (IR) sensor.

The cover opening detecting part 155f may be disposed on at least one of inner and outer walls of the gear box 155. For example, the single cover opening detecting part 155f may be disposed on the inner surface of the gear box 155. In this case, the cover opening detecting part 155f may detect that the push protrusion 151 is positioned at the initial position.

As another example, the two cover opening detecting parts 155f may be disposed on the outer surface of the gear box 155. In this case, the cover opening detecting part 155f may detect the initial position and the cover opening position of the push protrusion 151.

Accordingly, according to the present disclosure, the cover opening unit 150 may open the dust bin 220 even though the user separately opens the discharge cover 222 of the cleaner, and as a result, it is possible to improve convenience.

In addition, since the discharge cover 222 is opened in the state in which the cleaner 200 is coupled to the cleaner station 100, it is possible to prevent the dust from scattering.

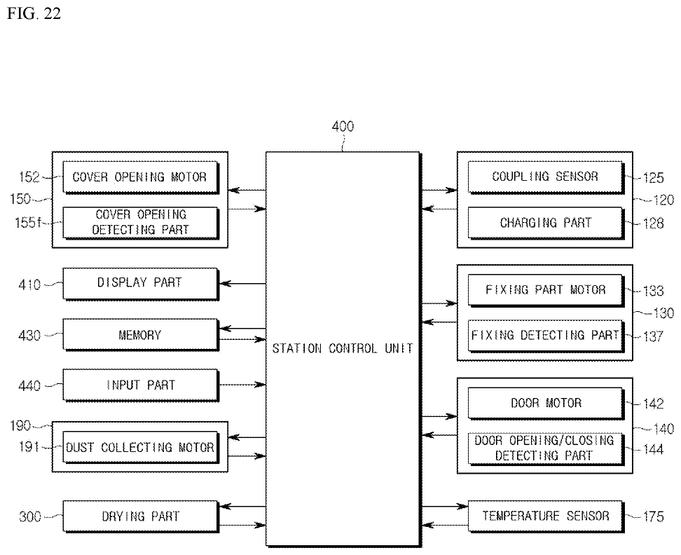

Meanwhile, the dust collecting part 170 will be described below with reference to FIGS. 2 and 22.

The cleaner station 100 may include the dust collecting part 170. The dust collecting part 170 may be disposed in the housing 110. The dust collecting part 170 may be disposed at the lower side of the coupling part 120 based on the gravitational direction.

The dust collecting part 170 may capture the dust in the dust bin 220 of the cleaner 200. Specifically, when the dust collecting motor 191 operates in the state in which the cleaner 200 is coupled to the cleaner station 100 and the dust passage hole 121a and the suction flow path 180 communicate with each other, the dust in the dust bin 220 may be captured in the dust collecting part 170 by the suction force of the dust collecting motor 191 while flowing along the suction flow path 180.

The dust collecting part 170 may include a dust bag 171 and a dust collecting chamber 172.

The dust in the dust bin 220 may be captured in the dust bag 171. The dust bag 171 may collect the dust sucked from the dust bin 220 of the cleaner 200 by the dust collecting motor 191.

The dust bag 171 may be disposed in the housing 110. The dust bag 171 may be disposed at the lower side of the coupling part 120. One end of the dust bag 171 may be connected to the other end of the suction flow path 180 connected to the dust passage hole 121a formed in the coupling surface 121. In this case, the suction flow path 180 may be connected to an upper surface of the dust bag 171.

The dust bag 171 may be accommodated in an accommodation space defined in the dust collecting chamber 172. The accommodation space may be formed in a shape similar to a hexahedral shape. However, the present disclosure is not limited thereto. The accommodation space may be formed in other polyhedral or cylindrical shapes.

An internal space (hereinafter, referred to as a ‘capturing space’), in which the dust discharged from the dust bin 220 of the cleaner 200 is captured, may be formed in the dust bag 171, and air may flow in a capturing space 1711. Further, the capturing space 1711 may communicate with the suction flow path 180. Specifically, the capturing space 1711 may communicate with a second suction flow path 182 of the suction flow path 180. In this case, the second suction flow path 182, which communicates with the capturing space 1711, may be opened or closed by a flow path cover 183.

A space (hereinafter, referred to as an ‘intermediate space’) with a predetermined interval may be formed between an outer peripheral surface of the dust bag 171 and an inner peripheral surface of the dust collecting chamber 172, and air may flow through an intermediate space 1721. Further, the intermediate space 1721 may communicate with a discharge flow path 160. Specifically, the intermediate space 1721 may communicate with a first discharge flow path 161.

In this case, the intermediate space 1721 may be a part of the accommodation space that accommodates the dust bag 171. That is, the intermediate space 1721 may mean a space with a predetermined interval defined between the outer peripheral surface of the dust bag 171 and the inner peripheral surface of the dust collecting chamber 172 when the dust bag 171 is accommodated in the accommodation space.

Meanwhile, when the suction force is generated by the dust collecting motor 191, a volume of the dust bag 171 is increased, such that the dust may be accommodated in the dust bag 310. The dust in the dust bin 220 of the cleaner 200 may be captured in the capturing space 1711 of the dust bag 171 by the suction force generated by the dust collecting motor 191.

To this end, the dust bag 171 may be made of a material that transmits air but does not transmit foreign substances such as dust. For example, the dust bag 171 may be made of a non-woven fabric material and have a hexahedral shape when the dust bag 171 has an increased volume. Therefore, the air passing through the dust bag 171 may dry the capturing space 1711 while flowing between the capturing space 1711 and the intermediate space 1721.

On the contrary, the dust bag 171 may be made of an impermeable material. For example, the dust bag 171 may include a roll vinyl film (not illustrated). With this configuration, the dust bag 171 is sealed or joined, which may prevent dust or offensive odor captured in the dust bag 171 from leaking to the outside from the dust bag 171.

In this case, the dust bag 171 may be mounted in the housing 110 by means of a dust bag cartridge (not illustrated). As necessary, the dust bag 171 may be replaced by means of the dust bag cartridge. The dust bag 171 may be detachably coupled to the housing 110. Therefore, the dust bag 171 may be separated from the housing 110 and discarded, a new dust bag 171 may be coupled to the housing 110. That is, the dust bag 171 may be defined as a consumable component. A volume of the dust bag 171 may be increased by the suction force (negative pressure), which is generated when the dust collecting motor 191 operates, in the state in which the dust bag 171 is mounted in the housing. In this case, the dust bag 171 in a spread state may be accommodated in the dust collecting chamber 172. That is, the dust bag 171 may expand in the dust collecting chamber 172 when the dust collecting motor 191 operates. Further, the dust bag 171 in the spread state may be supported by the dust collecting chamber 172, such that a shape of the dust bag 171 may be maintained.

In addition, a drying part 300 to be described below may dry the capturing space 1711 by generating an airflow flowing between the intermediate space 1721 and the capturing space 1711.

The dust collecting chamber 172 may define an external shape of the dust collecting part 170 and define the accommodation space capable of accommodating the dust bag 171.

The dust collecting chamber 172 may be formed in a shape similar to a hexahedral shape. However, the present disclosure is not limited thereto. The dust collecting chamber may be formed in other polyhedral or cylindrical shapes.

The dust collecting chamber 172 may be disposed in the housing 110. The dust collecting chamber 172 may be disposed at the lower side of the coupling part 120. With this configuration, when the dust bag 171 expands downward, at least a part of the dust bag 171 may be accommodated in the accommodation space of the dust collecting chamber 172. In this case, the accommodation space may be formed in a shape similar to a hexahedral shape. However, the present disclosure is not limited thereto. The accommodation space may be formed in other polyhedral or cylindrical shapes.

The intermediate space 1721 with a predetermined interval may be formed between the inner peripheral surface of the dust collecting chamber 172 and the outer peripheral surface of the dust bag 171, and air may flow in the intermediate space 1721. Further, the intermediate space 1721 may communicate with the discharge flow path 160. Specifically, the intermediate space 1721 may communicate with the first discharge flow path 161.

For example, the discharge flow path 160 may guide at least a part of the air, which flows in the dust collecting chamber 172, to the outside of the housing 110. That is, the air, which absorbs moisture in the capturing space 1711 while flowing between the intermediate space 1721 and the capturing space 1711, may flow through the discharge flow path 160 and be discharged to the outside of the housing 110.

As another example, at least a part of the air, which flows in the dust collecting chamber 172, may circulate together with air present outside the housing 110 through the discharge flow path 160. That is, the discharge flow path 160 may guide the air in the intermediate space 1721 to the outside of the housing 110. On the contrary, the discharge flow path 160 may guide the air in the housing 110 to the intermediate space 1721.

Meanwhile, the intermediate space 1721 may be a part of the accommodation space that accommodates the dust bag 171. The intermediate space 1721 may mean a space with a predetermined interval defined between the outer peripheral surface of the dust bag 171 and the inner peripheral surface of the dust collecting chamber 172 when the dust bag 171 is accommodated in the accommodation space.

Meanwhile, a temperature sensor 175 may be provided in the dust collecting part 170. The temperature sensor 175 may measure a temperature in the dust collecting part 170. A control unit 400 may receive information on the temperature measured by the temperature sensor 175.

Meanwhile, according to the embodiment, the temperature sensor 175 may be provided in the dust suction module 190. In case that the temperature sensor 175 is provided in the dust suction module 190, the temperature sensor 175 may measure a temperature of the dust collecting motor 191 or a temperature of air discharged from the dust collecting motor 191.

Meanwhile, the suction flow path 180 will be described with reference to FIGS. 2 and 9.

The cleaner station 100 may include the suction flow path 180.

The suction flow path 180 may connect the dust collecting part 170 and the dust passage hole 121a formed in the coupling surface 121a. One end of the suction flow path 180 may be connected to the dust passage hole 121a, and the other end of the suction flow path 180 may be connected to the dust collecting part 170. The suction flow path 180 may be disposed at a rear side of the coupling surface 121. The suction flow path 180 may mean a space between the dust bin 220 of the cleaner 200 and the dust collecting part 170. The suction flow path 180 may be a space formed at a rear side of the dust passage hole 121a. The suction flow path 180 may be a flow path bent downward from the dust passage hole 121a, and the dust and the air may flow through the suction flow path 180.

Specifically, the suction flow path 180 may include a first suction flow path 181 and the second suction flow path 182. When the cleaner 200 is coupled to the cleaner station 100 and the dust passage hole 121a is opened, the first suction flow path 181 may communicate with the internal space of the dust bin 220, and the second suction flow path 182 may allow the first suction flow path 181 to communicate with the capturing space 1711 of the dust bag 171.

For example, the first suction flow path 181 may be disposed to be substantially parallel to an axis of the suction motor 214 or an imaginary through-line that penetrates the dust bin 220. In this case, the axis of the suction motor 214 or the through-line of the dust bin 220 may penetrate the first suction flow path 181.

In this case, the second suction flow path 182 may be provided at a predetermined angle with respect to the first suction flow path 181. For example, an angle between the first suction flow path 181 and the second suction flow path 182 may be a right angle. With this configuration, it is possible to minimize an overall volume of the cleaner station 100.

Meanwhile, a length of the first suction flow path 181 may be equal to or shorter than a length of the second suction flow path 182. With this configuration, the suction force of the dust collecting motor 191 may be transmitted to the space in the dust bin 220 even though the entire flow path for removing the dust is bent once.

The dust in the dust bin 220 of the cleaner 200 may move to the dust collecting part 170 through the suction flow path 180.

The flow path cover 183 configured to open or close the suction flow path 180 may be provided at one side of the suction flow path 180. The flow path cover 183 may be provided at an end of the suction flow path 180 to open or close the suction flow path 180 that communicates with the dust bag 171. Specifically, the flow path cover 183 may be provided at an end of the second suction flow path 182 to open or close the second suction flow path 182 that communicates with the capturing space 1711 of the dust bag 171.

In this case, a flow path cover actuator (not illustrated) may be provided at one side of the flow path cover 183 and provide power for operating the flow path cover 183. Therefore, when the flow path cover actuator (not illustrated) operates, the flow path cover 183 may open or close the second suction flow path 182.

Specifically, the flow path cover 183 may close the second suction flow path 182 while the drying part 300 dries the capturing space 1711 by generating an airflow flowing between the interior of the dust bag 171 and the interior of the dust collecting chamber 172. Therefore, even though the drying part 300 generates the airflow in the capturing space 1711, the dust captured in the capturing space 1711 may not scatter toward the suction flow path 180.

Meanwhile, the dust suction module 190 will be described below with reference to FIGS. 2 and 22.

The cleaner station 100 may include the dust suction module 190. The dust suction module 190 may include the dust collecting motor 191, a first filter 192, and a second filter (not illustrated).

The dust collecting motor 191 may be disposed below the dust collecting part 170. The dust collecting motor 191 may provide a suction force to the suction flow path 180. Therefore, the dust collecting motor 191 may provide a suction force capable of sucking the dust in the dust bin 220 of the cleaner 200.

The dust collecting motor 191 may generate the suction force by means of the rotation. For example, the dust collecting motor 191 may be formed in a shape similar to a cylindrical shape.

Meanwhile, in the present embodiment, an imaginary dust collecting motor axis C may be defined by extending the rotation axis of the dust collecting motor 191.

The first filter 192 may be disposed between the dust collecting part 170 and the dust collecting motor 191. The first filter 192 may be a prefilter. The air passing through the first filter 192 may flow to the internal space in which the dust collecting motor is accommodated.

The second filter (not illustrated) may be disposed between the dust collecting motor 191 and the outer wall surface 112. The second filter (not illustrated) may be an HEPA filter.

Meanwhile, the cleaner station 100 may further include a charging part 128. The charging part may be disposed on the coupling part 120. The charging part 128 may be electrically connected to the cleaner 200 coupled to the coupling part 120. The charging part 128 may supply power to the battery of the cleaner 200 coupled to the coupling part 120.

In addition, the cleaner station 100 may further include a lateral door (not illustrated). The lateral door may be disposed in the housing 110. The lateral door may selectively expose the dust collecting part 170 to the outside. Therefore, the user may easily remove the dust collecting part 170 from the cleaner station 100.

In addition, the cleaner station 100 may further include a discharge port 1621. The discharge port 1621 may be formed in the housing 110. For example, the discharge port 1621 may be formed at a lower side of the housing 110 and connected to the dust collecting motor 191 through a second discharge flow path 162. Therefore, the air passing through the dust collecting motor 191 may be discharged to the outside of the housing 110 through the discharge port 1621.

Meanwhile, with reference to FIGS. 2 and 11 to 21, the cleaner station 100 may further include the discharge flow path 160.

The discharge flow path 160 may be installed at one side of the dust collecting chamber 172 and guide the air, which flows in the dust collecting chamber 172, to the outside of the housing 110.

The discharge flow path 160 may include the first discharge flow path 161 and the second discharge flow path 162. The first discharge flow path 161 may connect the dust collecting chamber 172 and the dust suction module 190. Specifically, the first discharge flow path 161 may connect the intermediate space 1721 of the dust collecting chamber 172 and the internal space in which the dust collecting motor 191 is accommodated.

One end of the first discharge flow path 161 may be connected to the intermediate space 1721 of the dust collecting chamber 172, and the other end of the first discharge flow path 161 may be connected to the internal space in which the dust collecting motor 191 is accommodated.

The first discharge flow path 161 may be a flow path formed in a vertical direction in the housing 110. One end of the first discharge flow path 161 may be connected to the intermediate space 1721 of the dust collecting chamber 172, and the other end of the first discharge flow path 161 may be connected to the internal space in which the dust collecting motor 191 is accommodated.

For example, the air discharged from the intermediate space 1721 may pass through the first filter 192 and then flow to the internal space, in which the dust collecting motor 191 is accommodated, through the first discharge flow path 161. As another example, the air discharged from the intermediate space 1721 may pass through the first filter 192 through the first discharge flow path 161 and then flow to the internal space in which the dust collecting motor 191 is accommodated. That is, the air in the intermediate space 1721 may flow through the first discharge flow path 161 and enter the internal space in which the dust collecting motor 191 is accommodated.

The second discharge flow path 162 may guide the air, which is introduced into the internal space, in which the dust collecting motor 191 is accommodated, through the first discharge flow path 161, to the outside of the housing 110. That is, the air, which flows in the internal space in which the dust collecting motor 191 is accommodated, may flow through the second discharge flow path 162 and be discharged to the outside of the housing 110.

Meanwhile, the second discharge flow path 162 may guide the air, which is discharged from the dust collecting motor 191 when the dust collecting motor 191 operates, to the outside of the housing 110. The second discharge flow path 162 may provide a flow path in which the air discharged from the dust collecting motor 191 flows. That is, the air discharged from the dust collecting motor 191 may flow through the second discharge flow path 162 and be discharged to the outside of the housing 110.

One end of the second discharge flow path 162 may communicate with the internal space of the dust suction module 190, in which the dust collecting motor 191 is accommodated, and the other end of the second discharge flow path 162 may communicate with the discharge port 1621. The second discharge flow path 162 may be a flow path formed in a horizontal direction in the housing 110. One end of the second discharge flow path 162 may communicate with the internal space in which the dust collecting motor 191 is accommodated, and the other end of the second discharge flow path 162 may communicate with the discharge port 1621.

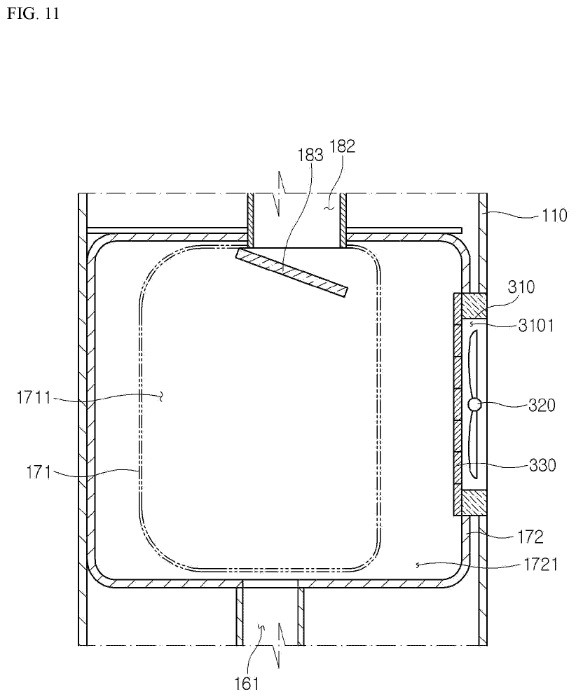

Meanwhile, with reference to FIGS. 11 to 21, the cleaner station 100 may include the drying part 300.

The drying part 300 may dry the interior of the dust bag 171 by generating an airflow to be introduced into the dust bag 171 in the dust collecting chamber 172.

In this case, the dust bag 171 may be made of a material that transmits air but does not transmit foreign substances such as dust. For example, the dust bag 171 may be made of a non-woven fabric material and have a hexahedral shape when the dust bag 171 has an increased volume. Therefore, the air passing through the dust bag 171 may dry the capturing space 1711 while flowing between the capturing space 1711 and the intermediate space 1721.

The drying part 300 may dry the interior of the dust bag 171 by supplying room-temperature air or hot air into the dust bag 171 in the dust collecting chamber 172. For example, the drying part 300 may dry the capturing space 1711 by transmitting the air present outside the housing 110 to the capturing space 1711. As another example, the drying part 300 may dry the capturing space 1711 by exchanging the air in the capturing space 1711 and the air in the intermediate space 1721. As still another example, the drying part 300 may dry the capturing space 1711 by providing a blowing airflow to the capturing space 1711 through a flow path that allows the capturing space 1711 and the intermediate space 1721 to communicate with each other.

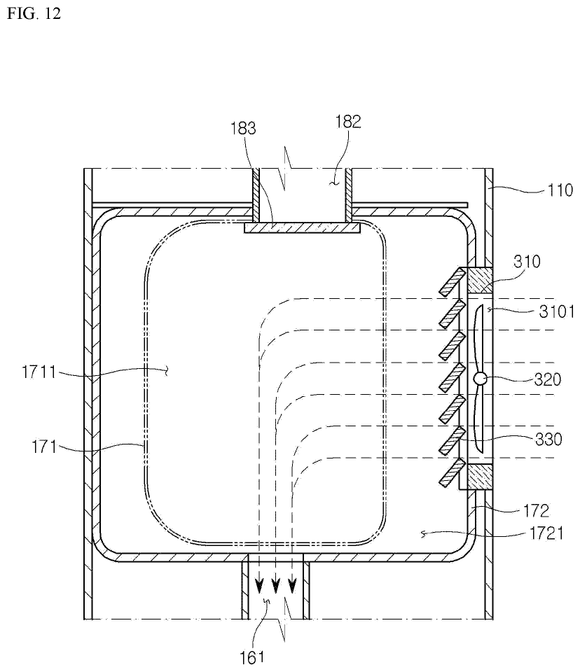

Hereinafter, a cleaner station according to a first embodiment of the present disclosure will be described with reference to FIGS. 11 and 12.

The drying part 300 of the cleaner station according to the first embodiment of the present disclosure may include an air inlet port 310, a blower fan 320, and a shutter 330.

The air inlet port 310 may allow the inside of the dust collecting chamber 172 and the outside of the housing 110 to communicate with each other. Specifically, the air inlet port 310 may allow the intermediate space 1721 of the dust collecting chamber 172 and the outside of the housing 110 to communicate with each other.

For example, the air inlet port 310 may be formed in a lateral surface of the dust collecting chamber 172. The air inlet port 310 may be formed in the lateral surface of the dust collecting chamber 172 and allow the intermediate space 1721 and the outside of the housing 110 to communicate with each other. The air present outside the housing 110 may flow through the air inlet port 310, which is formed in the lateral surface of the dust collecting chamber 172, and be introduced into the intermediate space 1721.

Meanwhile, the air inlet port 310 may provide a flow path (hereinafter, referred to as an ‘air inflow path’) in which air may flow. An air inflow path 3101 may guide the air present outside the housing 110 into the dust collecting chamber 172. Specifically, the air inflow path 3101 may guide the air present outside the housing 110 to the intermediate space 1721 of the dust collecting chamber 172. Therefore, the air present outside the housing 110 may be introduced into the intermediate space 1721 through the air inflow path 3101.

The blower fan 320 may introduce the air present outside the housing 110 into the dust collecting chamber 172 through the air inlet port 310. Specifically, the blower fan 320 may introduce the air present outside the housing 110 into the intermediate space 1721 through the air inlet port 310.

Meanwhile, the air, which is introduced from the outside of the housing 110 into the intermediate space 1721 by means of the blower fan 320, may be allowed to pass through the dust bag 171 by the airflow discharged from the blower fan 320 and then flow in the capturing space 1711. That is, the air, which is introduced into the dust collecting chamber 172 by means of the blower fan 320, may dry the capturing space 1711 while flowing between the intermediate space 1721 and the capturing space 1711.

For example, the air, which passes through the air inlet port 310 by the blower fan 320, may be introduced into the intermediate space 1721 and then pass through the dust bag 171, thereby absorbing moisture in the capturing space 1711. Further, the air, which has absorbed moisture in the capturing space 1711, may be allowed to pass through the dust bag 171 again by the airflow, which is discharged from the blower fan 320, and then discharged to the outside of the housing 110 through the discharge flow path 160 that communicates with the interior of the dust collecting chamber 172. Specifically, the air, which has absorbed moisture in the capturing space 1711, may flow to the intermediate space 1721 while passing through the dust bag 171 and be introduced into the internal space, in which the dust collecting motor 191 is accommodated, through the first discharge flow path 161 that communicates with the intermediate space 1721. The air introduced into the internal space may be discharged to the outside of the housing 110 through the second discharge flow path 162 that communicates with the internal space.

As another example, the air present outside the housing 110 may be introduced into the intermediate space 1721 by the blower fan 320 and then circulate through the capturing space 1711 and the intermediate space 1721 while repeatedly passing through the dust bag 171. In this case, at least a part of the air, which circulates through the capturing space 1711 and the intermediate space 1721, may be discharged to the outside of the housing 110 through the discharge flow path 160. Specifically, the air, which has passed through the dust bag 171, may be introduced into the internal space, in which the dust collecting motor 191 is accommodated, through the first discharge flow path 161, which communicates with the intermediate space 1721, and then the air may be discharged to the outside of the housing 110 through the second discharge flow path 162 that communicates with the internal space.

That is, the air, which is introduced from the outside of the housing 110 by the blower fan 320, may dry the capturing space 1711 while passing through the dust bag 171 and flowing between the intermediate space 1721 and the capturing space 1711.

The blower fan 320 may be disposed in the air inlet port 310. For example, the blower fan 320 may be disposed at an inlet side of the air inflow path 3101 that communicates with the outside of the housing 110. As another example, the blower fan 320 may be disposed at an outlet side of the air inflow path 3101 that communicates with the intermediate space 1721.

Meanwhile, the blower fan 320 may operate in the state in which the flow path cover 183 closes the suction flow path 180. Specifically, the blower fan 320 may operate in the state in which the flow path cover 183 closes the second suction flow path 182. The flow path cover 183 may close the second suction flow path 182 while the blower fan 320 dries the capturing space 1711 by introducing the air present outside the housing 110 into the dust collecting chamber 172. Therefore, the captured dust may not scatter toward the suction flow path 180 even though an airflow is generated in the capturing space 1711 while the blower fan 320 operates.

The shutter 330 may be disposed in a direction in which air is discharged from the blower fan 320. The blower fan 320 may introduce the air into the dust collecting chamber 172 in the state in which the shutter 330 opens the air inlet port 310. Specifically, the blower fan 320 may introduce the air present outside the housing 110 into the intermediate space 1721 in the state in which the shutter 330 opens the air inlet port 310.

The drying part 300 may include a blower fan motor (not illustrated) configured to provide power for operating the blower fan 320. Therefore, when the blower fan motor (not illustrated) operates, the blower fan 320 may operate and introduce the air present outside the housing 110 into the intermediate space 1721 of the dust collecting chamber 172 through the air inlet port 310.

The shutter 330 may open or close the air inlet port 310. The shutter 330 may be disposed forward of the blower fan 320. Specifically, the shutter 330 may be disposed in the direction in which the air is discharged from the blower fan 320.

The blower fan 320 may introduce the air into the dust collecting chamber 172 in the state in which the shutter 330 opens the air inlet port 310. Specifically, the blower fan 320 may introduce the air into the intermediate space 1721 of the dust collecting chamber 172 in the state in which the shutter 330 opens the air inlet port 310.

In this case, the shutter 330 may selectively open or close the air inlet port 310 depending on whether the blower fan 320 operates. In the state in which the blower fan 320 operates, the shutter 330 may open the air inlet port 310 to introduce the air present outside the housing 110. In contrast, in the state in which the operation of the blower fan 320 is stopped, the shutter 330 may close the air inlet port 310 to seal the dust collecting chamber 172. With this configuration, it is possible to prevent the air present outside the housing 110 from being introduced into the dust collecting chamber 172 through the air inlet port 310 in the state in which the operation of the blower fan 320 is stopped.

Meanwhile, the shutter 330 may adjust a flow direction of the air discharged from the blower fan 320. That is, the flow direction of the air discharged from the blower fan 320 may be switched by adjusting an angle at which the shutter 330 is opened. For example, an opening angle of the shutter 330 may be adjusted within an angle range of 10 degrees or more and 70 degrees or less based on a position at which the shutter 330 closes the air inlet port 310. With this configuration, the air, which is introduced into the intermediate space 1721 by means of the blower fan 320, may pass through the dust bag 171 and dry the capturing space 1711. The air, which has dried the capturing space 1711, may pass through the dust bag 171 again and be discharged to the outside of the housing 110 through the discharge flow path 160 connected to the dust collecting chamber 172.

Meanwhile, the drying part 300 may include a shutter actuator (not illustrated) configured to provide power for operating the shutter 330. Therefore, when the shutter actuator (not illustrated) operates, the shutter 330 may open or close the air inlet port 310 and determine whether to introduce the air, which is discharged from the blower fan 320, into the dust collecting chamber 172.

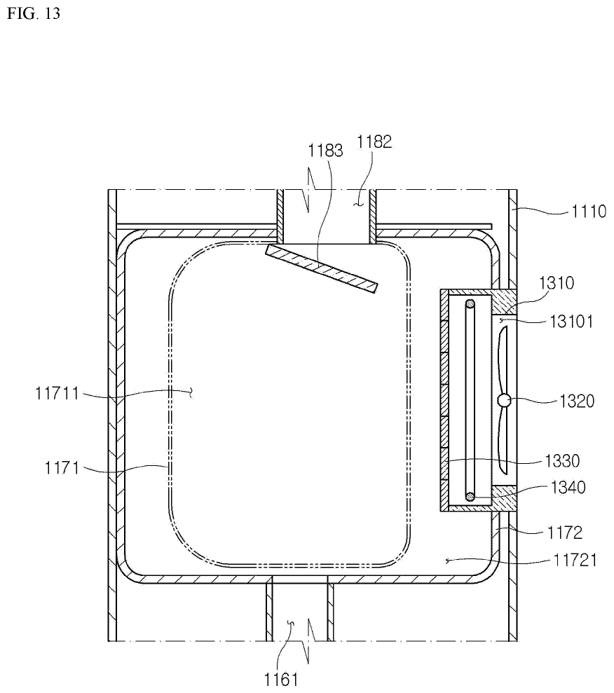

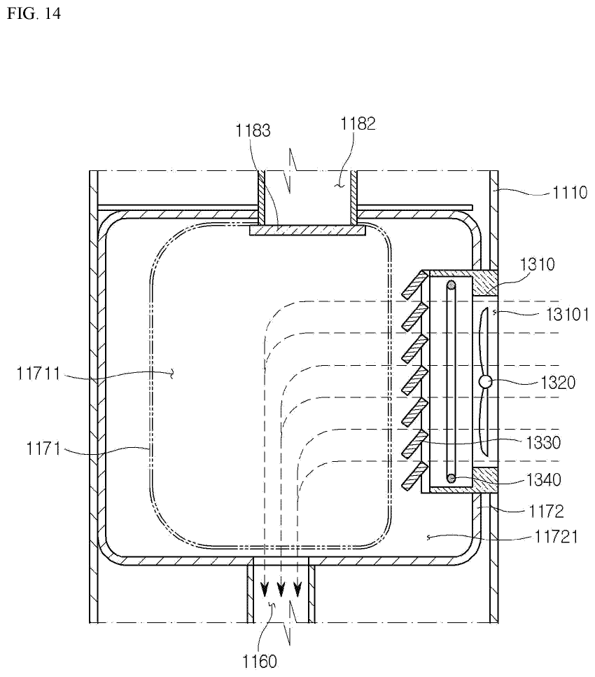

Hereinafter, a cleaner station according to a second embodiment of the present disclosure will be described with reference to FIGS. 13 and 14.

A drying part 1300 of the cleaner station according to the second embodiment of the present disclosure may include an air inlet port 1310, a blower fan 1320, a shutter 1330, and a heater 1340.

In order to avoid a repeated description, the description of the air inlet port 1310, the blower fan 1320, and the shutter 1330 of the second in the embodiment may be replaced with the description of the air inlet port 310, the blower fan 320, and the shutter 330 of the drying part of the cleaner station according to the first embodiment of the present disclosure.

The drying part 1300 of cleaner station according to the second embodiment of the present disclosure may dry an interior of a dust bag 1171 by supplying hot air into the dust bag 1171. That is, the drying part 1300 may dry the interior of the dust bag 1171 by heating the air discharged from the blower fan 1320 by means of the heater 1340.

The heater 1340 may heat the air present outside a housing 1110 that is to be introduced into a dust collecting chamber 1172 by the blower fan 1320. Specifically, the heater 1340 may heat the air present outside the housing 1110 that is to be introduced into an intermediate space 11721 by the blower fan 1320.

The air heated by the heater 1340 increases a temperature of a capturing space 11711 and a temperature of the intermediate space 11721 while flowing in the dust collecting chamber 1172, thereby reducing a humidity in the dust collecting chamber 172.

Meanwhile, the heater 1340 may be disposed in the air inlet port 1310. Specifically, the heater 1340 may be provided along an inner peripheral surface of an air inflow path 13101. For example, the heater 1340 may be provided in an annular shape along the inner peripheral surface of the air inflow path 13101.

For example, the heater 1340 may be disposed in a direction in which the air is discharged from the blower fan 1320. In this case, the shutter 1330 may be disposed in the direction in which the air is discharged from the blower fan 1320, and the heater 1340 may be disposed between the blower fan 1320 and the shutter 1330.

As another example, the heater 1340 may be disposed in the direction in which the air is introduced from the blower fan 1320.

As still another example, the heater 1340 may be disposed on an outer surface of the housing 1110. That is, the specific shape or arrangement of the heater 1340 is not restricted as long as the heater 1340 may heat the air introduced through the air inlet port 1310.

The heater 1340 may heat the air introduced into the intermediate space 11721 in the state in which the blower fan 1320 operates. When the shutter 1330 opens the air inlet port 1310 in the state in which the blower fan 1320 operates, the heater 1340 may heat the air flowing through the air inlet port 1310.

For example, the heater 1340 may operate when a predetermined time elapses after the operation of the blower fan 1320 is initiated. The heater 1340 may operate after the blower fan 1320 operates for a period of time of 7 seconds or more and 8 seconds or less. However, the present disclosure is not limited thereto. The time may be set and changed depending on an output of the blower fan motor (not illustrated), which provides power to the blower fan 1320, and a humidity of the capturing space 11711.

As another example, the heater 1340 may operate at the same time when the operation of the blower fan 1320 is initiated.

As still another example, the blower fan 1320 may operate after the air inlet port 310 is preheated as the heater 1340 operates for a predetermined time. The blower fan 1320 may operate after the heater 1340 operates for a period of time of 7 seconds or more and 8 seconds or less. However, the present disclosure is not limited thereto. The time may be set and changed depending on a temperature of the air inlet port 1310, which is preheated by the heater 1340, and a humidity of the capturing space 11711.

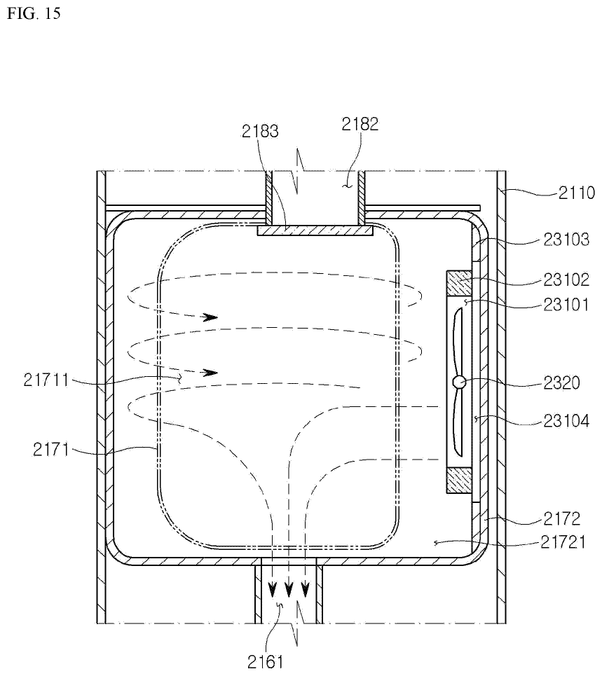

Hereinafter, a cleaner station according to a third embodiment of the present disclosure will be described with reference to FIG. 15.

A drying part 2300 of the cleaner station according to the third embodiment of the present disclosure may include a blower fan 2320.

The blower fan 2320 may be disposed in a dust collecting chamber 2172. The blower fan 2320 may be disposed in an intermediate space 21721 of the dust collecting chamber 2172.

The blower fan 2320 may be disposed in a blower fan housing 23102 having an air inflow path 23101 in which air may flow. The blower fan housing 23102 may be formed in a cylindrical shape having a hollow portion therein and have the air inflow path 23101 in which the air discharged from the blower fan 2320 flows. That is, the blower fan 2320 may be disposed in the air inflow path 23101.

The blower fan housing 23102 may be supported by a support wall 23103 formed on an inner surface of the dust collecting chamber 2172. A recessed space 23104 may be formed in the support wall 23103. The recessed space 23104 may be recessed by a predetermined depth and communicate with the air inflow path 23101. Therefore, the air in the intermediate space 21721 may be introduced into the air inflow path 23101 through the recessed space 23104 by a suction force of the blower fan 2320 and then discharged forward from the blower fan 2320.

Meanwhile, the blower fan 2320 may generate an airflow that circulates through a capturing space 21711 and the intermediate space 21721, and the airflow may flow while passing through a dust bag 2171.

The blower fan 2320 may discharge the air in a direction toward the dust bag 2171. The air discharged from the blower fan 2320 may pass through the dust bag 2171 and circulate the air present inside the dust bag 2171 and the air present outside the dust bag 2171. That is, the air discharged from the blower fan 2320 may pass through the dust bag 2171 and circulate through the capturing space 21711 and the intermediate space 21721. The air, which is circulated through the interior of the dust collecting chamber 2172 by the blower fan 2320, may reduce a humidity of the capturing space 21711 while exchanging the air in the capturing space 21711 and the air in the intermediate space 21721.

For example, the air discharged from the blower fan 2320 may pass through the dust bag 2171 and flow in the capturing space 21711. The air flowing in the capturing space 21711 may absorb moisture in the capturing space 21711. Further, the air, which has absorbed moisture in the capturing space 21711, may be allowed to pass through the dust bag 2171 again by the airflow, which is discharged from the blower fan 2320, and flow in the intermediate space 21721.

In this case, at least a part of the air, which has absorbed moisture in the capturing space 21711, may be discharged to the outside of a housing 2110 through a discharge flow path 2160. Specifically, the air, which has passed through the capturing space 21711, may absorb moisture in the capturing space 21711 and then flow to the intermediate space 21721 while passing through the dust bag 2171 again. The air may be introduced into an internal space, in which a dust collecting motor 2191 is accommodated, through a first discharge flow path 2161 that communicates with the intermediate space 21721. Further, the air introduced into the internal space may be discharged to the outside of the housing 2110 through the second discharge flow path 2162 that communicates with the internal space.

Meanwhile, the air discharged from the blower fan 2320 may pass through the dust bag 2171 and dry the capturing space 21711 while circulating through the intermediate space 21721 and the capturing space 21711. In this case, at least a part of the air, which circulates through the capturing space 21711 and the intermediate space 21721, may be discharged to the outside of the housing 2110 through the discharge flow path 2160.

The blower fan 2320 may be disposed in the dust collecting chamber 2172. For example, the blower fan 2320 may be disposed on a lateral surface of the dust collecting chamber 2172. As another example, the blower fan 2320 may be disposed at a lower side of the dust collecting chamber 2172.

Meanwhile, the blower fan 2320 may operate in a state in which a flow path cover 2183 closes a suction flow path 2180. Specifically, the blower fan 2320 may operate in a state in which the flow path cover 2183 closes a second suction flow path 2182. The flow path cover 2183 may close the suction flow path 2180 while the blower fan 2320 dries the capturing space 21711 by generating the airflow that passes through the dust bag 2171. Therefore, the captured dust may not scatter toward the suction flow path 2180 even though the airflow is generated in the capturing space 21711 while the blower fan 2320 operates.

Meanwhile, the drying part 2300 may include a blower fan motor (not illustrated) configured to provide power for operating the blower fan 2320. Therefore, when the blower fan motor (not illustrated) operates, the blower fan 2320 may operate and generate the airflow that circulates through the interior of the dust collecting chamber 2172.

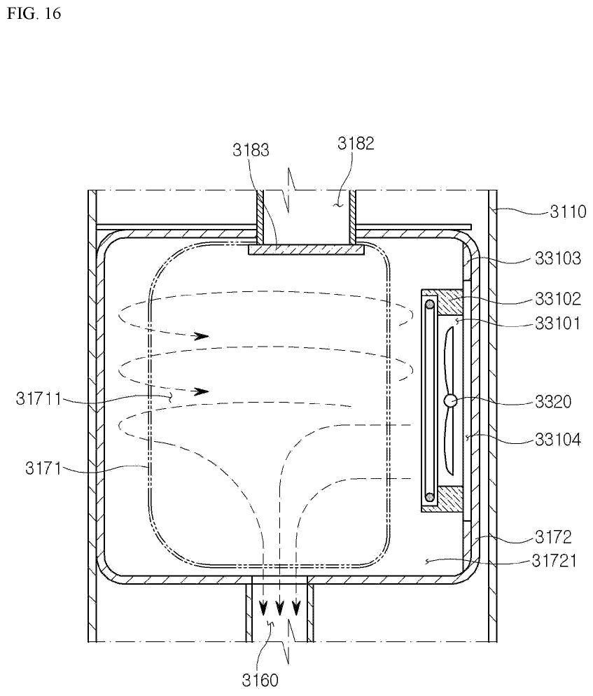

Hereinafter, a cleaner station according to a fourth embodiment of the present disclosure will be described with reference to FIG. 16.

A drying part 3300 of the cleaner station according to the fourth embodiment of the present disclosure may include a blower fan 3320 and a heater 3340.

In order to avoid a repeated description, the description of the blower fan 3320 of the fourth embodiment may be replaced with the description of the blower fan 2320 of the drying part of the cleaner station according to the third embodiment of the present disclosure.

The drying part 3300 of cleaner station according to the fourth embodiment of the present disclosure may dry an interior of a dust bag 3171 by supplying hot air into the dust bag 3171. That is, the drying part 3300 may dry the interior of the dust bag 3171 by heating the air discharged from the blower fan 3320 by means of the heater 3340.

The heater 3340 may heat the air discharged from the blower fan 3320. The heater 3340 may heat the air that circulates through an intermediate space 31721 and a capturing space 31711 while passing through the dust bag 3171.

The air heated by the heater 3340 increases a temperature of the capturing space 31711 and a temperature of the intermediate space 31721 while flowing in the dust collecting chamber 3172, thereby reducing a humidity in the dust collecting chamber 3172.

Meanwhile, the heater 3340 may be disposed in an air inflow path 33101. Specifically, the heater 3340 may be provided along an inner peripheral surface of the air inflow path 33101. For example, the heater 3340 may be provided in an annular shape along the inner peripheral surface of the air inflow path 33101.

The heater 3340 may be disposed in a direction in which the air is discharged from the blower fan 3320. Alternatively, the heater 3340 may be disposed in a direction in which the air is introduced from the blower fan 3320. That is, a specific shape or arrangement is not limited as long as the heat may heat the air discharged from the blower fan 3320.

The heater 3340 may heat the air discharged from the blower fan 3320 in a state in which the blower fan 3320 operates.

For example, the heater 3340 may operate when a predetermined time elapses after the operation of the blower fan 3320 is initiated. The heater 3340 may operate after the blower fan 3320 operates for a period of time of 7 seconds or more and 8 seconds or less. However, the present disclosure is not limited thereto. The time may be set and changed depending on an output of the blower fan motor (not illustrated), which provides power to the blower fan 3320, and a humidity of the capturing space 31711.

As another example, the heater 3340 may operate at the same time when the operation of the blower fan 3320 is initiated.

As still another example, the blower fan 3320 may operate after the heater 3340 preheats air in front of the blower fan 3320 as the heater 3340 operates for a predetermined time. The blower fan 3320 may operate after the heater 3340 operates for a period of time of 7 seconds or more and 8 seconds or less. However, the present disclosure is not limited thereto. The time may be set and changed depending on a temperature of the air in front of the blower fan 3320, which is preheated by the heater 3340, and a humidity of the capturing space 31711.

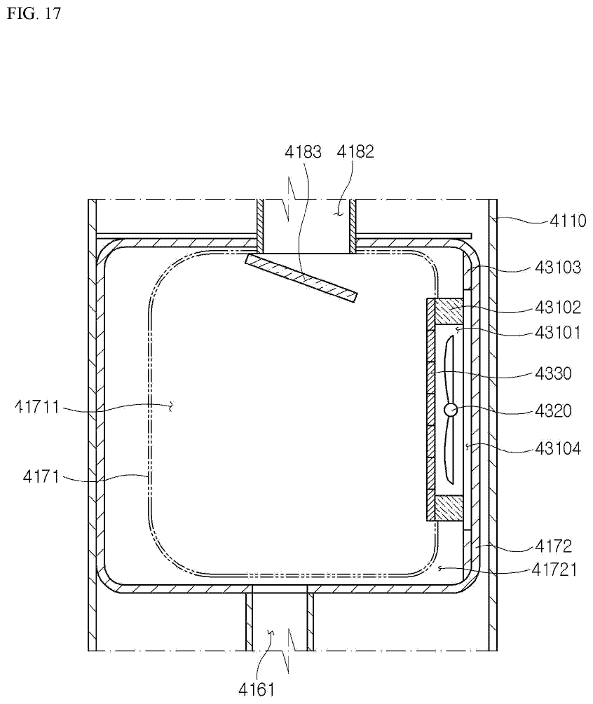

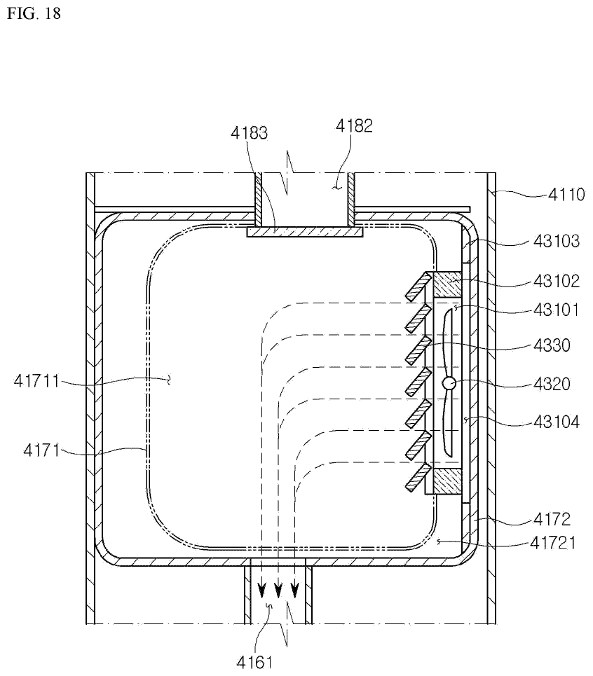

Hereinafter, a cleaner station according to a fifth embodiment of the present disclosure will be described with reference to FIGS. 17 and 18.

A drying part 4300 of the cleaner station according to the fifth embodiment of the present disclosure may include an air inlet port 4310, a blower fan 4320, and a shutter 4330.

The air inlet port 4310 may allow an interior of a dust bag 4171 to communicate with an intermediate space 41721 formed between an outer peripheral surface of the dust bag 4171 and an inner peripheral surface of a dust collecting chamber 4172. That is, the air inlet port 4310 may allow a capturing space 41711 and the intermediate space 41721 to communicate with each other.

For example, the air inlet port 4310 may be formed in a lateral surface of the dust bag 4171. The air inlet port 4310 may be formed in an outer surface of the dust collecting chamber 4172 and allow the capturing space 41711 and the intermediate space 41721 to communicate with each other. The air in the intermediate space 41721 may flow through the air inlet port 4310, which is formed in a lateral surface of the dust bag 4171, and be introduced into the capturing space 41711.

Meanwhile, the air inlet port 4310 may provide a flow path (hereinafter, referred to as an ‘air inflow path’) in which air may flow. An air inflow path 43101 may guide the air present outside the dust bag 4171 into the dust bag 4171. Specifically, the air inflow path 43101 may provide a flow path that guides the air in the intermediate space 41721 to the capturing space 41711. Therefore, the air in the intermediate space 41721 may be introduced into the capturing space 41711 through the air inflow path 43101.

The blower fan 4320 may be disposed in a blower fan housing 43102 having the air inflow path 43101 in which air may flow. The blower fan housing 43102 may be formed in a cylindrical shape having a hollow portion therein and have the air inflow path 43101 in which the air discharged from the blower fan 4320 flows. That is, the blower fan 4320 may be disposed in the air inflow path 43101.

For example, the blower fan housing 43101 may be supported by a lateral surface of the dust bag 4171 and a support wall 43103 formed on an inner surface of the dust collecting chamber 4172. A recessed space 43104 may be formed in the support wall 43103. The recessed space 43104 may be recessed by a predetermined depth and communicate with the air inflow path 43101. Therefore, the air in the intermediate space 41721 may be introduced into the air inflow path 43101 through the recessed space 43104 by a suction force of the blower fan 4320 and then discharged to the capturing space 41711.

As another example, the blower fan housing 43102 may be supported by the lateral surface of the dust bag 4171. Therefore, the air in the intermediate space 41721 may be allowed to flow through the air inflow path 43101 by a suction force of the blower fan 4320 and discharged to the capturing space 41711.

The blower fan 4320 may introduce the air present outside the dust bag 4171 into the dust bag 4171 through the air inlet port 4310. Specifically, the blower fan 4320 may introduce the air in the intermediate space 41721 into the capturing space 41711 through the air inlet port 4310.

Meanwhile, the air in the intermediate space 41721 may be introduced into the capturing space 41711 by means of the blower fan 4320 and allowed to flow in the capturing space 41711 by the airflow discharged from the blower fan 4320. That is, the air, which is introduced into the capturing space 41711 through the blower fan 4320, may dry the capturing space 41711 while flowing between the intermediate space 41721 and the capturing space 41711. Specifically, the air, which is introduced into the capturing space 41711 from the intermediate space 41721 by the blower fan 4320, may dry the capturing space 41711 by absorbing moisture in the capturing space 41711.

For example, the air, which passes through the air inlet port 4310 by the blower fan 4320, may be introduced into the capturing space 41711 and absorb moisture in the capturing space 41711. Further, the air, which has absorbed moisture in the capturing space 41711, may be allowed to pass through the dust bag 4171 by the airflow, which is discharged from the blower fan 4320, and then discharged to the outside of a housing 4110 through a discharge flow path 4160 connected to the dust collecting chamber 4172. That is, the air, which is introduced into the capturing space 41711 by the blower fan 4320, may pass through the dust bag 4171, and then the air may flow through the discharge flow path 4160 and be discharged to the outside of the housing 4110.

Specifically, the air introduced into the capturing space 41711 may absorb moisture in the capturing space 41711 and then flow to the intermediate space 41721 while passing through the dust bag 4171. The air may be introduced into an internal space, in which a dust collecting motor 4191 is accommodated, through a first discharge flow path 4161 that communicates with the intermediate space 41721. Further, the air introduced into the internal space may be discharged to the outside of the housing 4110 through a second discharge flow path 4162 that communicates with the internal space.

As another example, the air in the intermediate space 41721 is introduced into the capturing space 41711 by the blower fan 4320, and then the air may circulate through the capturing space 41711 and the intermediate space 41721 while repeatedly passing through the dust bag 4171. In this case, at least a part of the air, which circulates through the capturing space 41711 and the intermediate space 41721, may be discharged to the outside of the housing 4110 through the discharge flow path 4160. Specifically, at least a part of the air, which circulates through the capturing space 41711 and the intermediate space 41721, may be introduced into the internal space, in which the dust collecting motor 4191, is accommodated, through the first discharge flow path 4161 that communicates with the intermediate space 41721. Further, the air introduced into the internal space may be discharged to the outside of the housing 4110 through the second discharge flow path 4162 that communicates with the internal space.

The blower fan 4320 may be disposed in the air inlet port 4310. For example, the blower fan 4320 may be disposed at an inlet side of the air inflow path 43101 that communicates with the intermediate space 41721. As another example, the blower fan 4320 may be disposed at an outlet side of the air inflow path 43101 that communicates with the capturing space 41711.

Meanwhile, the blower fan 4320 may operate in a state in which a flow path cover 4183 closes a suction flow path 4180. Specifically, the blower fan 4320 may operate in a state in which the flow path cover 4183 closes a second suction flow path 4182. The flow path cover 4183 may close the second suction flow path 4182 while the blower fan 4320 dries the capturing space 41711 by introducing the air in the intermediate space 41721 into the capturing space 41711. Therefore, the captured dust may not scatter toward the suction flow path 4180 even though the airflow is generated in the capturing space 41711 while the blower fan 4320 operates.

The shutter 4330 may be disposed in a direction in which air is discharged from the blower fan 4320. The blower fan 4320 may introduce the air into the capturing space 41711 in the state in which the shutter 4330 opens the air inlet port 4310. Specifically, the blower fan 4320 may introduce the air in the intermediate space 41721 into the capturing space 41711 in the state in which the shutter 4330 opens the air inlet port 4310.

The drying part 4300 may include a blower fan motor (not illustrated) configured to provide power for operating the blower fan 4320. Therefore, when the blower fan motor (not illustrated) operates, the blower fan 4320 may operate and introduce the air present outside the housing 4110 into the intermediate space 41721 of the dust collecting chamber 4172 through the air inlet port 4310.

The shutter 4330 may open or close the air inlet port 4310. The shutter 4330 may be disposed forward of the blower fan 4320. Specifically, the shutter 4330 may be disposed in the direction in which the air is discharged from the blower fan 4320.

The blower fan 4320 may introduce the air into the dust bag 4171 in the state in which the shutter 4330 opens the air inlet port 4310. Specifically, the blower fan 4320 may introduce the air into the capturing space 41711 of the dust bag 4171 in the state in which the shutter 4330 opens the air inlet port 4310.

In this case, the shutter 4330 may selectively open or close the air inlet port 4310 depending on whether the blower fan 4320 operates. In the state in which the blower fan 4320 operates, the shutter 4330 may open the air inlet port 4310 to introduce the air present outside the housing 110. In contrast, in the state in which the operation of the blower fan 4320 is stopped, the shutter 4330 may close the air inlet port 4310 and prevent the dust in the capturing space 41711 from scattering through the air inlet port 4310.

Meanwhile, the shutter 4330 may adjust a flow direction of the air discharged from the blower fan 4320. That is, the flow direction of the air discharged from the blower fan 4320 may be switched by adjusting an angle at which the shutter 4330 is opened. For example, an opening angle of the shutter 4330 may be adjusted within an angle range of 10 degrees or more and 70 degrees or less based on a position at which the shutter 4330 closes the air inlet port 4310. With this configuration, the air, which is introduced into the capturing space 41711 through the blower fan 4320, may absorb moisture in the capturing space 41711, pass through the dust bag 4171, and be discharged to the outside.

Meanwhile, the drying part 4300 may include a shutter actuator (not illustrated) configured to provide power for operating the shutter 4330. Therefore, when the shutter actuator (not illustrated) operates, the shutter 4330 may open or close the air inlet port 4310 and selectively introduce the air, which is discharged from the blower fan 4320, into the intermediate space 41721.

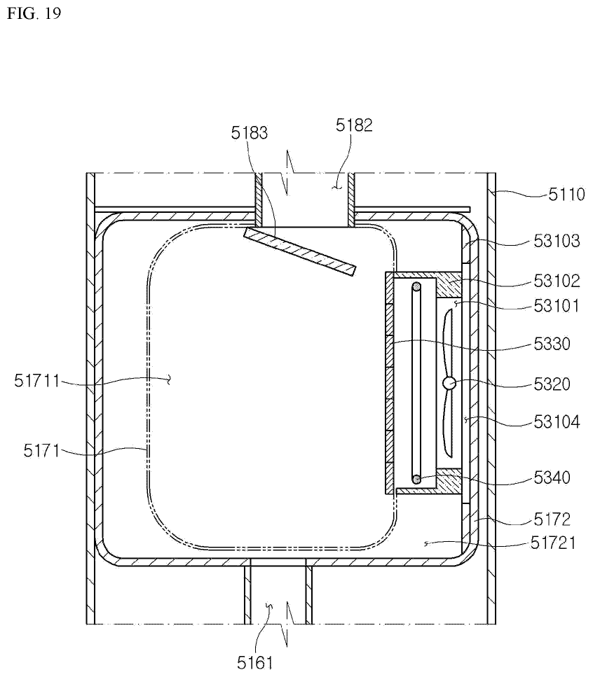

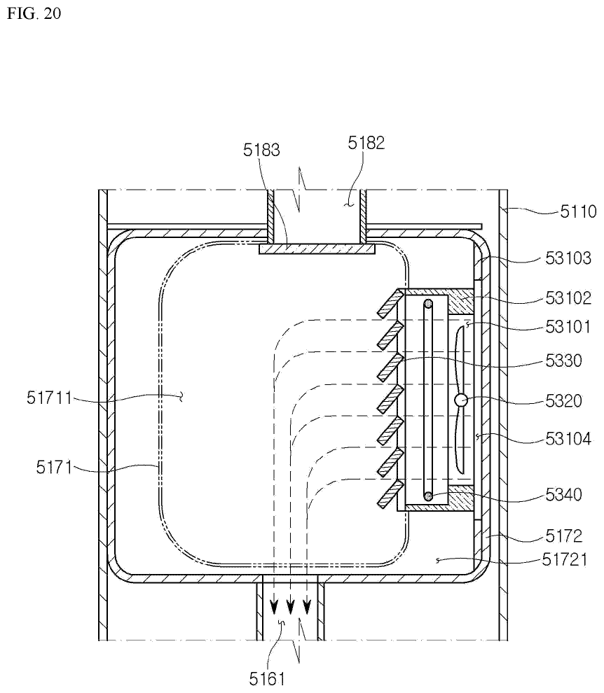

Hereinafter, a cleaner station according to a sixth embodiment of the present disclosure will be described with reference to FIGS. 19 and 20.

A drying part 5300 of the cleaner station according to the sixth embodiment of the present disclosure may include an air inlet port 5310, a blower fan 5320, a shutter 5330, and a heater 5340.

In order to avoid a repeated description, the description of the air inlet port 5310, the blower fan 5320, and the shutter 5330 of the sixth in the embodiment may be replaced with the description of the air inlet port 4310, the blower fan 4320, and the shutter 4330 of the drying part 4300 of the cleaner station according to the fifth embodiment of the present disclosure.

The drying part 5300 of cleaner station according to the sixth embodiment of the present disclosure may dry an interior of a dust bag 5171 by supplying hot air into the dust bag 5171. That is, the drying part 5300 may dry the interior of the dust bag 5171 by heating the air discharged from the blower fan 5320 by means of the heater 5340.

The heater 5340 may heat the air present outside the dust bag 5171 that is to be introduced into the dust bag 5171 by the blower fan 5320. Specifically, the heater 5340 may heat the air in an intermediate space 51721 that is to be introduced into a capturing space 51711 by the blower fan 5320.

The air heated by the heater 5340 may reduce a humidity while flowing in the capturing space 51711 and increasing a temperature of the capturing space 51711.

Meanwhile, the heater 5340 may be disposed in the air inlet port 5310. Specifically, the heater 5340 may be provided along an inner peripheral surface of an air inflow path 53101. For example, the heater 5340 may be provided in an annular shape along the inner peripheral surface of the air inflow path 53101.

For example, the heater 5340 may be disposed in a direction in which the air is discharged from the blower fan 5320. In this case, the shutter 5330 may be disposed in the direction in which the air is discharged from the blower fan 5320, and the heater 5340 may be disposed between the blower fan 5320 and the shutter 5330.

As another example, the heater 3340 may be disposed in the direction in which the air is introduced from the blower fan 3320.

As still another example, the heater 5340 may be disposed on an inner surface of the dust bag 5171. That is, the specific shape or arrangement of the heater 5340 is not restricted as long as the heater 5340 may heat the air introduced through the air inlet port 5310.

The heater 5340 may heat the air introduced into the capturing space 51711 in the state in which the blower fan 5320 operates. When the shutter 5330 opens the air inlet port 5310 in the state in which the blower fan 5320 operates, the heater 5340 may heat the air flowing through the air inlet port 5310.

For example, the heater 5340 may operate when a predetermined time elapses after the operation of the blower fan 5320 is initiated. The heater 5340 may operate after the blower fan 5320 operates for a period of time of 7 seconds or more and 8 seconds or less. However, the present disclosure is not limited thereto. The time may be set and changed depending on an output of the blower fan motor (not illustrated), which provides power to the blower fan 5320, and a humidity of the capturing space 51711.

As another example, the heater 5340 may operate at the same time when the operation of the blower fan 5320 is initiated.

As still another example, the blower fan 5320 may operate after the air inlet port 5310 is preheated as the heater 5340 operates for a predetermined time. The blower fan 5320 may operate after the heater 5340 operates for a period of time of 7 seconds or more and 8 seconds or less. However, the present disclosure is not limited thereto. The time may be set and changed depending on a temperature of the air inlet port 5310, which is preheated by the heater 5340, and a humidity of the capturing space 51711.

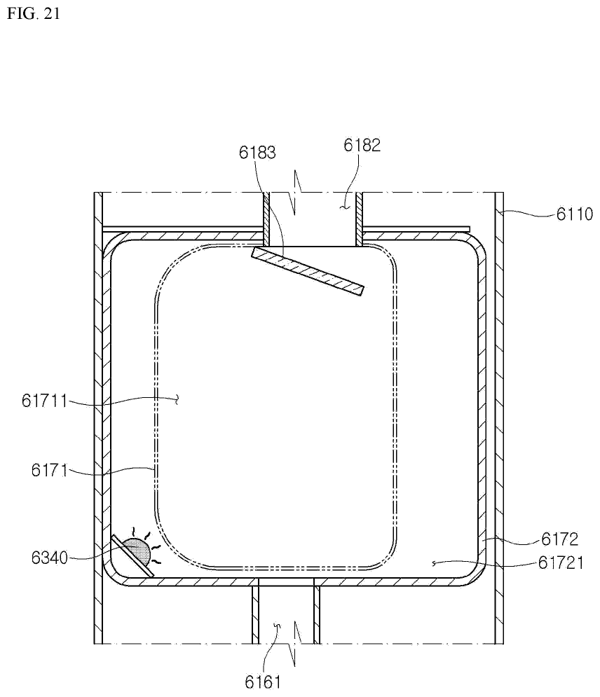

Hereinafter, a cleaner station according to a seventh embodiment of the present disclosure will be described with reference to FIG. 21.

A drying part 6300 of the cleaner station according to the seventh embodiment of the present disclosure may include a heater 6340.

The heater 6340 may be disposed in a dust collecting chamber 6172. Specifically, the heater 6340 may be disposed in an intermediate space 61721.

For example, the heater 6340 may be disposed at a lower side of the intermediate space 61721. The heater 6340, which is disposed at the lower side of the intermediate space 61721, may increase a temperature in the dust collecting chamber 6172 by emitting heat.

The heater 6340 may reduce a humidity in a capturing space 61711 by increasing a temperature of the capturing space 61711 by emitting heat toward a dust bag 6171. In this case, the heater 6340 may adjust an operating time and a temperature of the emitted heat on the basis of information on the temperature and humidity of the capturing space 61711.

Meanwhile, FIG. 22 is a block diagram for explaining a control configuration of the cleaner station according to the embodiment of the present disclosure.

The control configuration of the cleaner station 100 of the present disclosure will be described below with reference to FIG. 22.

The cleaner station 100 according to the embodiment of the present disclosure may further include the control unit 400 configured to control the coupling part 120, the fixing unit 130, the door unit 140, the cover opening unit 150, the dust collecting part 170, the suction flow path 180, the dust suction module 190, and the drying part 300.

The control unit 400 may include a printed circuit board and elements mounted on the printed circuit board.

When the coupling sensor 125 detects the coupling of the cleaner 200, the coupling sensor 125 may transmit a signal indicating that the cleaner 200 is coupled to the coupling part 120. In this case, the control unit 400 may receive the signal from the coupling sensor 125 and determine that the cleaner 200 is coupled to the coupling part 120.

In addition, when the charging part 128 supplies power to the battery 240 of the cleaner 200, the control unit 400 may determine that the cleaner 200 is coupled to the coupling part 120.

When the control unit 400 determines that the cleaner 200 is coupled to the coupling part 120, the control unit 400 may operate the fixing part motor 133 to fix the cleaner 200.

When the fixing members 131 or the fixing part links 135 are moved to a predetermined dust bin fixing position FP1, a fixing detecting part 137 may transmit a signal indicating that the cleaner 200 is fixed. The station control unit 400 may receive the signal, which indicates that the cleaner 200 is fixed, from the fixing detecting part 137, and determine that the cleaner 200 is fixed. When the control unit 400 determines that the cleaner 200 is fixed, the control unit 400 may stop the operation of the fixing part motor 133.

Meanwhile, when the operation of emptying the dust bin 220 is ended, the control unit 400 may rotate the fixing part motor 133 in the reverse direction to release the cleaner 200.

When the control unit 400 determines that the cleaner 200 is fixed to the coupling part 120, the control unit 400 may operate the door motor 142 to open the door 141 of the cleaner station 100.

When the door 141 or the door arm 143 reaches the predetermined opening position DP1, the door opening/closing detecting part 144 may transmit a signal indicating that the door 141 is opened. The control unit 400 may receive the signal, which indicates that the door 141 is opened, from the door opening/closing detecting part 137 and determine that the door 141 is opened. When the control unit 400 determines that the door 141 is opened, the control unit 400 may stop the operation of the door motor 142.

Meanwhile, when the operation of emptying the dust bin 220 is ended, the control unit 400 may rotate the door motor 142 in the reverse direction to close the door 141.

When the control unit 400 determines that the door 141 is opened, the control unit 400 may operate the cover opening motor 152 to open the discharge cover 222 of the cleaner 200.

When a guide frame 151e reaches the predetermined cover opening position CP1, the cover opening detecting part 155f may transmit a signal indicating that the discharge cover 222 is opened. The control unit 400 may receive the signal, which indicates that the discharge cover 222 is opened, from the cover opening detecting part 155f and determine that the discharge cover 222 is opened. When the control unit 400 determines that the discharge cover 222 is opened, the control unit 400 may stop the operation of the cover opening motor 152.

The control unit 400 may receive information on a temperature in the dust collecting part 170. For example, the control unit 400 may receive information on the temperature in the dust collecting part 170 by means of a temperature sensor 175. The control unit 400 may control the temperature in the dust collecting part 170 on the basis of the temperature information received from the temperature sensor 175.

The control unit 400 may control the drying part of the cleaner station according to the first to sixth embodiments of the present disclosure.

In order to avoid a repeated description, a process of controlling the drying part of the cleaner station according to the first and second embodiments of the present disclosure will be described below. The process of controlling the drying part of the cleaner station according to the remaining embodiments is identical to the control process to be described below, and thus the descriptions of the control processes may be replaced with one another.

The control unit 400 may operate the dust collecting motor 191 to suck the dust in the dust bin 220. The control unit 400 may operate the blower fan 320 in the state in which the flow path cover 183 closes the suction flow path 180. The control unit 400 may operate the blower fan 320 in the state in which the shutter 330 opens the air inlet port 310.

The control unit 400 may control the shutter 330 whether the blower fan 320 operates. For example, in the state in which the blower fan 320 operates, the control unit 400 may open the air inlet port 310 by operating the shutter 330. In contrast, in the state in which the operation of the blower fan 320 is stopped, the control unit 400 may close the air inlet port 310 by stopping the operation of the shutter 330.

The control unit 400 may adjust an angle at which the shutter 330 is opened. The control unit 400 may switch the flow direction of the air, which is discharged from the blower fan 320, by adjusting the opening angle of the shutter 330. For example, an opening angle of the shutter 330 may be adjusted within an angle range of 10 degrees or more and 70 degrees or less based on a position at which the shutter 330 closes the air inlet port 310.

The control unit 400 may operate the blower fan 320 in the state in which the flow path cover 183 closes the suction flow path 180. Specifically, the control unit 400 may operate the blower fan 320 in the state in which the flow path cover 183 closes the second suction flow path 182.

Meanwhile, the control unit 400 may operate the heater 1340 and heat the air discharged from the blower fan 1320. The control unit 400 may heat the air, which is discharged from the blower fan 1320, by operating the heater 1340 in the state in which the blower fan 1320 operates.

For example, the control unit 400 may operate the heater 1340 when a predetermined time elapses after the operation of the blower fan 1320 is initiated. The control unit 400 may operate the heater 1340 after operating the blower fan 1320 for a period of time of 7 seconds or more and 8 seconds or less. However, the present disclosure is not limited thereto. The time may be set and changed depending on an output of the blower fan motor (not illustrated), which provides power to the blower fan 1320, and a humidity of the capturing space 11711.

As another example, the control unit 400 may operate the heater 1340 at the same time when the operation of the blower fan 1320 is initiated.

As still another example, the control unit 400 may operate the blower fan 1320 after preheating the air in front of the blower fan 1320 by operating the heater 1340 for a predetermined time. The control unit 400 may operate the blower fan 1320 after operating the heater 1340 for a period of time of 7 seconds or more and 8 seconds or less. However, the present disclosure is not limited thereto. The time may be set and changed depending on a temperature of the air in front of the blower fan 1320, which is preheated by the heater 1340, and a humidity of the capturing space 11711.

The control unit 400 may control the drying part of the cleaner station according to the seventh embodiment of the present disclosure.

The control unit 400 may receive information on the temperature in a dust collecting part 6170 from the temperature sensor 175 and then adjust an operating time of the heater 6340 and a temperature of heat emitted from the heater 6340 on the basis of the information on the temperature received from the temperature sensor 175.

Meanwhile, the control unit 400 may receive the information on a humidity in the dust collecting part 6170 from a humidity sensor and adjust the operating time of the heater 6340 and the temperature of the heat emitted from the heater 6340 on the basis of the information on the humidity received from the humidity sensor.

The control unit 400 may operate the display part 410 to display a dust bin emptied situation and a charged situation of the cleaner 200.

Meanwhile, the cleaner station 100 according to the present disclosure may include the display part 410.

The display part 410 may be disposed on the housing 110, disposed on a separate display device, or disposed on a terminal such as a mobile phone.

The display part 410 may be configured to include at least any one of a display panel capable of outputting letters and/or figures and a speaker capable of outputting voice signals and sound. The user may easily ascertain a situation of a currently performed process, a residual time, and the like on the basis of information outputted through the display part.

Meanwhile, the cleaner station 100 according to the embodiment of the present disclosure may include a memory 430. The memory 430 may include various data for operating or driving the cleaner station 100.

Meanwhile, the cleaner station 100 according to the embodiment of the present disclosure may include an input part 440. The input part 440 generates key input data inputted by the user to control the operation of the cleaner station 100. To this end, the input part 440 may include a keypad, a dome switch, a touchpad (resistive touchpad/capacitive touchpad), and the like. In particular, in case that the touchpad defines a mutual layer structure together with the display part 410, the touchpad may be called a touch screen.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

1. A cleaner station comprising:
a housing;
a coupling part disposed in the housing and including a coupling surface to which at least a part of a cleaner is coupled;
a suction flow path having one end connected to a dust passage hole formed in the coupling surface;
a dust collecting part connected to the other end of the suction flow path and including a dust bag configured to capture dust in a dust bin of the cleaner, and a dust collecting chamber configured to accommodate the dust bag; and
a drying part configured to dry an interior of the dust bag by generating an airflow to be introduced into the dust bag in the dust collecting chamber.

2. The cleaner station of claim 1, wherein the drying part comprises:
an air inlet port configured to allow an interior of the dust collecting chamber and the outside of the housing to communicate with each other;
a blower fan configured to introduce air present outside the housing into the dust collecting chamber through the air inlet port; and
a shutter configured to open or close the air inlet port.

3. The cleaner station of claim 2, wherein the drying part comprises a heater configured to heat air introduced into the dust collecting chamber by the blower fan.

4. The cleaner station of claim 2, wherein the blower fan introduces air into the dust collecting chamber in a state in which the shutter opens the air inlet port.

5. The cleaner station of claim 1, wherein the drying part comprises a blower fan disposed in the dust collecting chamber and configured to circulate air inside the dust bag and outside air by generating an airflow that passes through the dust bag.

6. The cleaner station of claim 5, wherein the drying part comprises a heater configured to heat the air that circulates through the inside and outside of the dust bag by the blower fan.

7. The cleaner station of claim 1, wherein the drying part comprises:
an air inlet port configured to allow the interior of the dust bag to communicate with an intermediate space defined between an outer peripheral surface of the dust bag and an inner peripheral surface of the dust collecting chamber;
a blower fan configured to introduce air in the intermediate space into the dust bag through the air inlet port; and
a shutter configured to open or close the air inlet port.

8. The cleaner station of claim 7, wherein the drying part comprises a heater configured to heat air introduced into the dust bag by the blower fan.

9. The cleaner station of claim 7, wherein the blower fan introduces air into the dust bag in a state in which the shutter opens the air inlet port.

10. The cleaner station of claim 1, wherein a discharge flow path is provided at one side of the dust collecting chamber and guides at least a part of air, which flows in the dust collecting chamber, to the outside of the housing.

11. The cleaner station of claim 1, wherein a flow path cover configured to open or close the suction flow path is provided at one side of the suction flow path.

12. The cleaner station of claim 11, wherein the drying part generates an airflow to be introduced into the dust bag in the dust collecting chamber in a state in which the flow path cover closes the suction flow path.

13. A cleaner station comprising:
a housing;
a coupling part disposed in the housing and including a coupling surface to which at least a part of a cleaner is coupled;
a suction flow path having one end connected to a dust passage hole formed in the coupling surface;
a dust collecting part connected to the other end of the suction flow path and including a dust bag configured to capture dust in a dust bin of the cleaner, and a dust collecting chamber configured to accommodate the dust bag; and
a heater disposed in the dust collecting chamber.
